(19) United States
(12) Patent Application Publication
(10) Pub. No.: US 2014/0162220 A1
(43) Pub. Date: Jun. 12, 2014

(54) SYSTEM, METHOD AND COMPUTER PROGRAM PRODUCT FOR GAMIFICATION OF BUSINESS PROCESSES

(71) Applicant: QUEST 2 EXCEL, INC., Saratoga, CA (US)

(72) Inventors: Mahesh C. RAO, Saratoga, CA (US); Andrew Jay HOFFMAN, San Anselmo, CA (US); Marcello Rufus Hunter, Potomac Falls, VA (US); David E. Shough, El Dorado, CA (US)

(73) Assignee: QUEST 2 EXCEL, INC., Saratoga, CA (US)

(21) Appl. No.: 13/711,563

(22) Filed: Dec. 11, 2012

(51) Int. Cl. G09B 19/18

(52) U.S. Cl. CPC G09B 19/18
USPC 434/107

(57) ABSTRACT

A system combines project management, learning management, and content management in an augmented reality game. Significant business objectives correspond to “Quests” where a Quest includes Missions and Tasks. In the augmented reality game, individual employees are scored for individual Tasks in a game in which individuals can compare their point standing with other players.

### FIELD OF THE INVENTION

The present invention is generally related to business processes that include project management, learning management, and content management.

### BACKGROUND OF THE INVENTION

FIG. 1 illustrates the conventional project management approach used in many businesses. Project management is the discipline of planning, organizing, securing, managing, leading, and controlling resources to achieve specific goals. A project is a temporary endeavor with a defined beginning and end (usually time-constrained, and often constrained by funding or deliverables), undertaken to meet unique goals and objectives, typically to bring about beneficial change or added value.

The primary challenge of project management is to achieve all of the project's goals and objectives while honoring the preconceived constraints. The primary constraints are scope, time, and budget. Thus, in the example of FIG. 1, conventional project management software typically divides a project into a fixed set of tasks and assigns tasks to individual employees (task owners) to be completed according to a schedule.

Conventional project management approaches have many drawbacks. In particular, they often create work environments in which individuals narrowly focus on the task assigned to them based on the schedule and the budget. The work environment is often not mentally and emotionally stimulating for the task owners. Additionally, conventional project management approaches do not emphasize quality and creativity.

A further drawback of conventional project management systems is that they are not integrated with learning management. In many modern work environments, employees must also be trained and educated to learn various skills and background knowledge. Conventional approaches to learning management, such as giving employees lectures or intensive one-day trainings, often results in poor knowledge retention.

In view of the problems and drawbacks of the prior art, the inventors of the present application recognize that there is a need for new approaches to project management and learning management.

### SUMMARY OF THE INVENTION

Conventional project management focuses on scope, schedule, and budget, and is separate from learning management. An apparatus, system, method, and computer program product for implementing a business process as an augmented reality game is disclosed. In one embodiment, the augmented reality game is integrated with project management, learning management, and content management. In one embodiment, an individual choreographing game design utilizes a library of models, templates, and existing games to adapt an existing game or generate a new game for a new business process, which may include project management and/or learning management. An individual game is a Quest, where a Quest corresponds to a major business process or objective having Quests, corresponding to discrete projects, and each Quest has at least one Mission and each Mission has at least one Task. A scoring rubric permits individual players to be evaluated based on a set of criteria that may include quality criteria, in addition to other criteria. The credibility of individual evaluators may also be scored to adjust scores to increase fairness to players. A manager acts as a Quest Master and edits/defines a Quest to define players and other selectable attributes of the Quest. Employees play the game and earn scores that can be displayed in real time or on leader boards, adding the psychological benefits of game playing to conventional work processes that are conventionally handled by separate project management tools and learning management tools focusing on schedule, scope, and budget.

### BRIEF DESCRIPTION OF THE DRAWINGS

FIG. 1 illustrates project management in accordance with the prior art.

FIG. 2A illustrates a core system for gamification of business processes, including project management and learning management, in accordance with an embodiment of the present invention.

FIGS. 2B and 2C illustrate options for interfacing the core system of FIG. 2A with other systems and parties, in accordance with embodiments of the present invention.

FIG. 3 is a major system overview of user interactions of the core system of FIG. 2A, in accordance with an embodiment of the present invention

FIG. 4 illustrates major functions and interactions between a management layer, gamification units, and a learning content repository, in accordance with an embodiment of the present invention.

FIG. 5A is a flow chart illustrating a method of providing a business process as a Quest in an enterprise environment, and FIG. 5B is a flow chart illustrating a method of generating a Quest, in accordance with an embodiment of the present invention.

FIG. 6 is an example of a screenshot of an exemplary user interface for managing Quests, in accordance with an embodiment of the present invention.

FIG. 7 is an example of a screenshot of an exemplary user interface for adding a new Quest, Quest name, and Quest description, in accordance with an embodiment of the present invention.

FIG. 8 is an example of a screenshot of an exemplary user interface for editing a Quest and assigning members to the Quest, in accordance with an embodiment of the present invention.

FIG. 9 is an example of a screenshot of an exemplary user interface for Quest details, including Quest name, Quest description, assigned members, and list of Missions, in accordance with one embodiment of the present invention.

FIG. 10 is an example of a screenshot of an exemplary user interface to edit a Mission of a Quest, in accordance with an embodiment of the present invention.

FIG. 11 is an example of a screenshot of an exemplary user interface describing Mission Details and Mission Tasks in accordance with an embodiment of the present invention.

FIG. 12 is an example of a screen shot of an exemplary user interface for creating a Task, showing a Task instruction field, attachment and link fields, player field, respondent field, and prerequisite field in accordance with an embodiment of the present invention.

FIG. 13 is an example of a screenshot illustrating a generic invitation for a player to accept a new Task of a Mission of a Quest, in accordance with an embodiment of the present invention.

FIG. 14 is an example of a screenshot of an exemplary user interface for a player to indicate that a Task is done and have respondents score the Task, in accordance with an embodiment of the present invention.

FIG. 15 is an example of a screen shot of the Task Details page as viewed by a respondent, illustrating a rating button, in accordance with an embodiment of the present invention.

FIG. 16 is an example of a screenshot illustrating a rating rubric generated for a respondent to score a completed Task based on a set of criteria of the rubric, in accordance with an embodiment of the present invention.

FIG. 17 illustrates how all of the Missions and Tasks of a Quest are completed before completing a Quest, in accordance with an embodiment of the present invention.

FIG. 18 is an example of a screenshot illustrating a management rubric, in accordance with an embodiment of the present invention.

FIG. 19 illustrates a project specific leader board, in accordance with an embodiment of the present invention.

FIG. 20 is an example of a screenshot of a user interface illustrating the incorporation of learning activities into Tasks, in accordance with an embodiment of the present invention.

FIG. 21 is an example of a screenshot illustrating a leader board for overall Quest standings in an organization, in accordance with an embodiment of the present invention.

FIG. 22 is an example of a screenshot illustrating the editing of a rubric for a Learning Task including quality criteria, in accordance with an embodiment of the present invention.

FIG. 23 illustrates an interaction between the core system and an administrative complex in which the learning content repository of the core system is an access controlled subset of the administrative complex's master controlled repository, in accordance with an embodiment of the present invention.

FIG. 24 is an example of a screenshot illustrating editing a Task to include attached links, in accordance with an embodiment of the present invention.

FIG. 25 illustrates the administrative complex and the master content repository control, in accordance with an embodiment of the present invention.

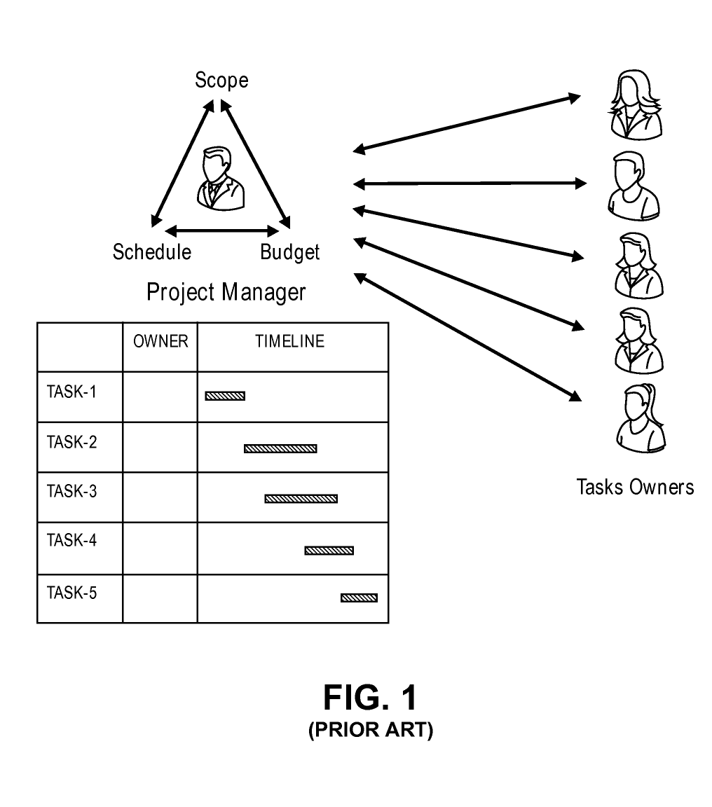

### DETAILED DESCRIPTION

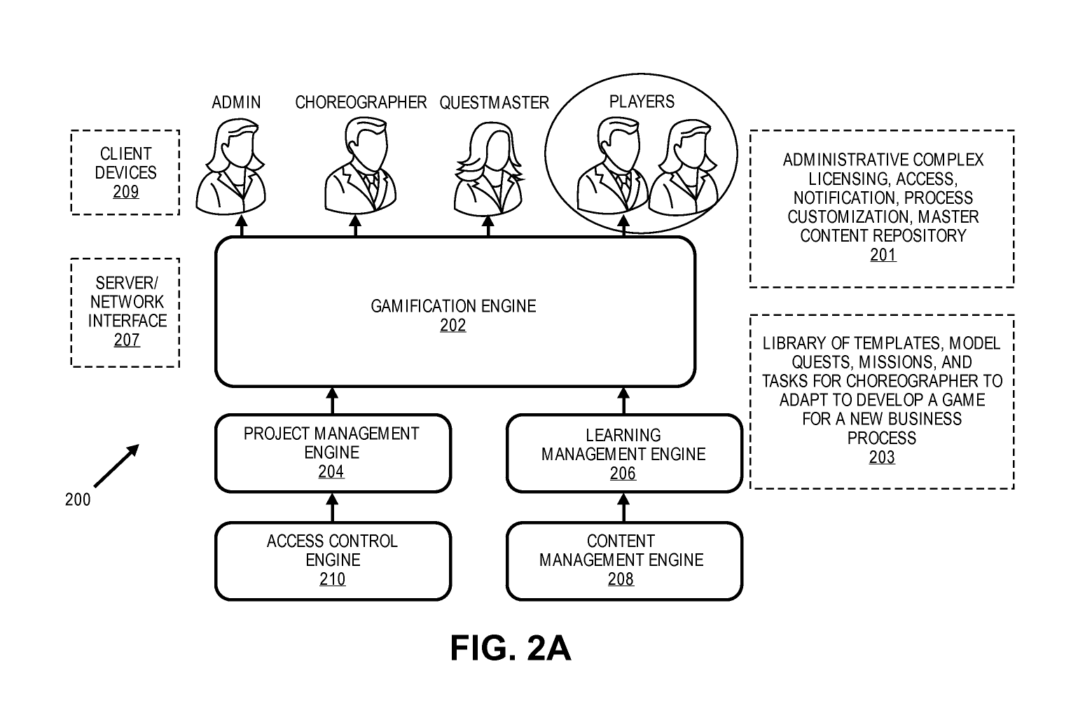

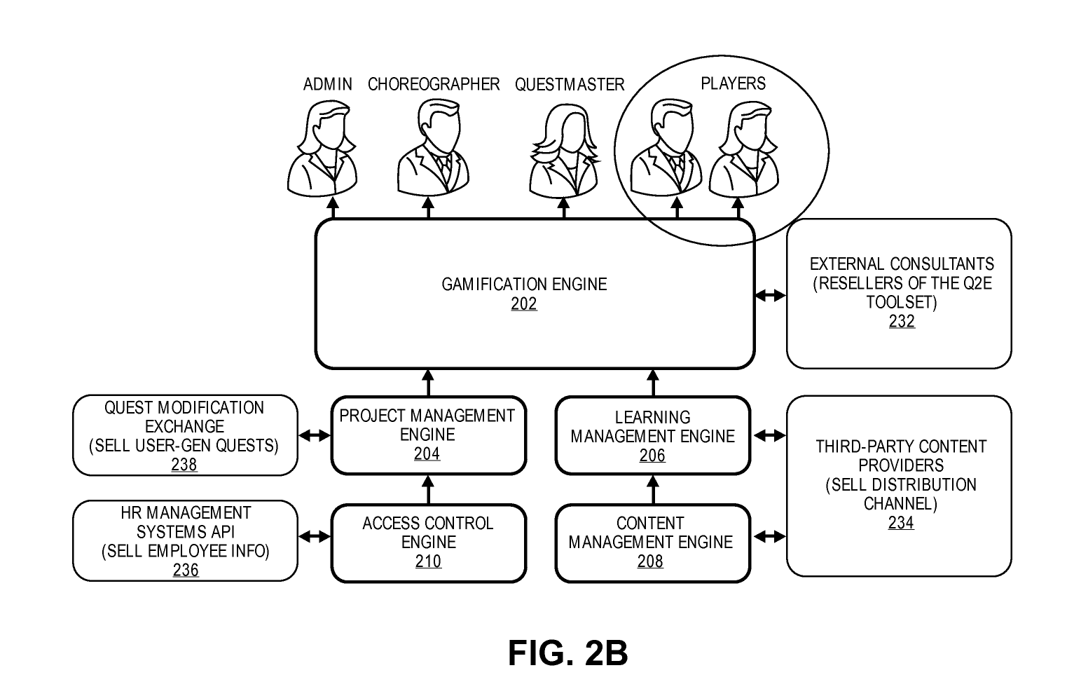

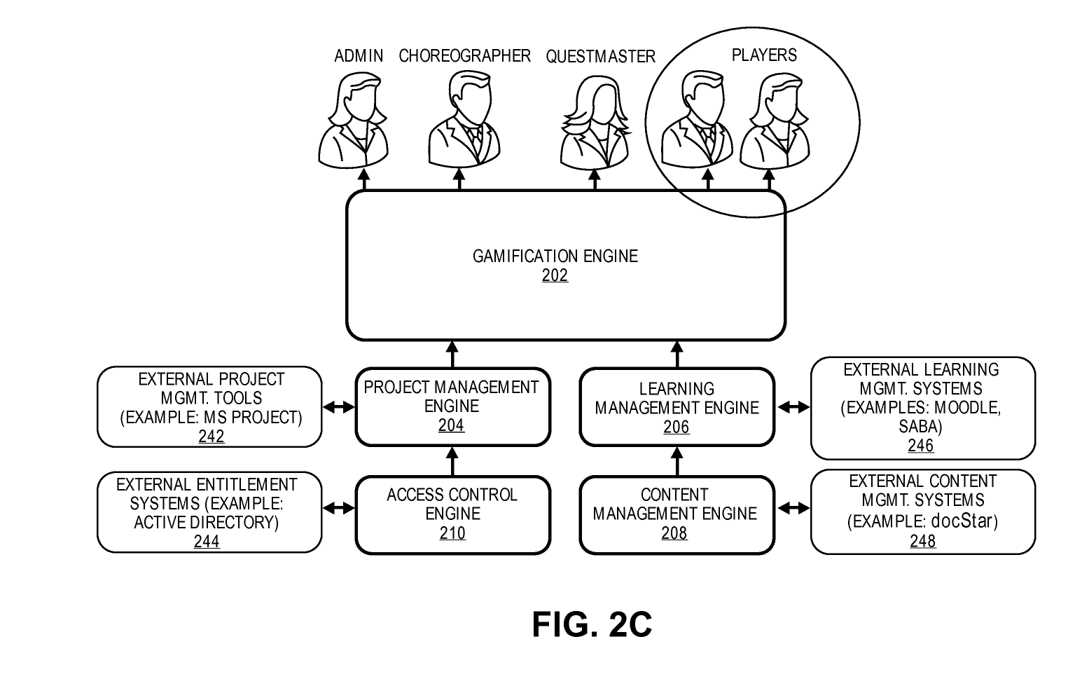

FIG. 2A is a block diagram of an embodiment of a core system 200 combining a project management system, learning management systems, and content management in an augmented reality game. System 200 could reside at a worksite of an organization. Alternatively, it will be understood that the functions could be provided remotely via system 200 using, for example, a secure server and secure storage to perform the functions of at least some of the components. Additionally, system 200 supports the generation of graphical user interfaces for managers, players, and administrators. An exemplary application is for system 200 to be networked to employees of an organization in an enterprise environment, and thus, individual employees have controlled access to various features via user interface, such as graphical user interface display interfaces, and email alerts and invitations. In one embodiment the system supports web access, such as by providing web access via a web server 207 (or other networked configuration) to a client device 209 (e.g., a device with an interactive display, such as a computer or a mobile computing device with wireless access, such as a tablet computer or smartphone).

A current name for a product corresponding to core system 200 is “Quest2Excel” (which is also known as “Q2E”). The system 200 has associated with it an administrative complex 201 to provide administrative functions. The design of a new game (for a new type of business process) may be supported by a library of templates 203 and models that can be accessed and edited to create a new game, wherein an individual game includes provision to define individual attributes and select various features and options of the game within the parameters set forth by a game designer.

Gamification of work processes is integral to the Quest2Excel system 200. Gamification is the use of game elements and game design techniques in non-game contexts. The system 200 provides a combination of project, learning and content management software systems into a game environment that innovate the workplace through turning the specific activities of work into a game through a system of respondents, rubrics and scoring. Additionally, there may be scoring with work and learning at each stage of any project.

In one embodiment, the Quest2Excel system applies many game elements including: points, levels of attainment, leader boards, rewards, Quests, and Missions. The system applies gaming techniques including scoring, progression of individuals, competition, going on Quests, completing Missions, use of social graphs, and rewards for completed Tasks. It applies these elements and design techniques to the everyday workplace and everyday work projects and tasks. The “player's view” is very much like a game with the motivations inherent in gaming.

In one embodiment, work is organized in the augmented reality game into Quests, where a Quest generally corresponds to a business process that is a large-scale effort expected to take a substantial amount of time relative to common business time-scales (e.g., a business quarter or a fiscal year). Thus, an individual Quest extends over a sufficient period of time to encompass a variety of work activities. In one embodiment, a Quest extends over a substantial part of at least one business quarter and may extend over more than one business quarter. As an illustrative example, an individual Quest might take four to eight months to complete. An individual phase of a Quest is a Mission, where a Mission is a significant and discrete portion of a Quest. A Mission thus has an expected duration that is a fraction of the total expected playing time of the Quest, where the duration of a Mission will depend upon the expected length of the Quest and the number of Mission phases in the Quest. In one implementation, a Mission extends over time periods that are significant subsets of a business quarter, e.g., at least one month. As an illustrative example, an individual Mission may extend over a period of four-to-eight weeks. An individual Mission includes at least one Task, where a Task is a discrete activity within a Mission.

Project management activities and learning management activities are converted into a game in which employees of the enterprise may serve as players; a project manager may serve as a master (“Quest Master”); a person or entity that choreographs game activity to reach a business objective is a “choreographer,” where a choreographer would often be an external business consultant; and an administrator is a person or entity that administers the system. The system provides users an opportunity to execute common business processes within the context of an augmented reality game, in order to help users better learn their jobs, improve their execution skills, and be more productive and successful on the job.

At a high level, the Quest2Excel system 200 combines a gamification engine 202, project management engine 204, learning management engine 206, and a content management engine 208. An access control engine 210 may be included.

FIG. 2B illustrates how the system may interact with external consultants 232, third party content provider 234s, HR management systems API 236, and a modification exchange 238.

FIG. 2C illustrates how the Quest2Excel 200 system may interface with other common enterprise systems, such as external project management tools 242, external entitlement systems 244, external learning management systems 246, and external content management systems 248.

The Quest2Excel core system 200 is an eco-system for enterprises, drawing together work processes, business consultants and learning resources into a single exchange. The system creates several complementary innovations. First, it creates a transparent, effective and motivating environment for completing work projects, such as the development of a new product or an as-is assessment. Second, it increases the efficiency of consultancy in business, whereby a single consultant can now work with perhaps ten times or more as many organizations or projects as was possible before, providing the enterprise with guidance in its work processes and tools to resolve organizational challenges, such as lack of communication or deficient knowledge, skills and abilities among employees. Finally, because the system includes a library of content keyed to specific work processes, third-party content providers can use the system to distribute their content in a process-appropriate, just-in-time manner, improving learning for employees and developing a channel for content providers at the highest point of need.

The systems' capacity to organize work effort into Quests, Missions, and Tasks, communicate openly and visually about the work effort, reward desired results and behaviors, and connect specific work activities to a library of content and templates tailored to those activities and provides the initial value that our eco-system's partners can leverage. The system for managing work processes allows a consultant to have much greater control over how a business operates with much less work, and allows business content providers an opportunity to target their offerings.

The Quest2Excel system 200 includes a hardware component of the platform (such as computer processors, memory, interfaces, content storage units, and an enterprise server or servers), as well as software components of the platform to implement the augmented reality game, project management, learning management, and content management, where the software components of the platform may be stored on a non-transitory computer readable storage medium and executed on one or more computer processors in the system. An exemplary application environment is enterprise environments. The system 200 could be implemented in the field at client sites, such as at individual companies. Alternatively, the system 200 could be implemented as a web service available from a central service using, for example, secure servers and secure storage. As one option, a consulting agency could work with a service provider to provide a centralized service offering Quest services to individual companies and organizations.

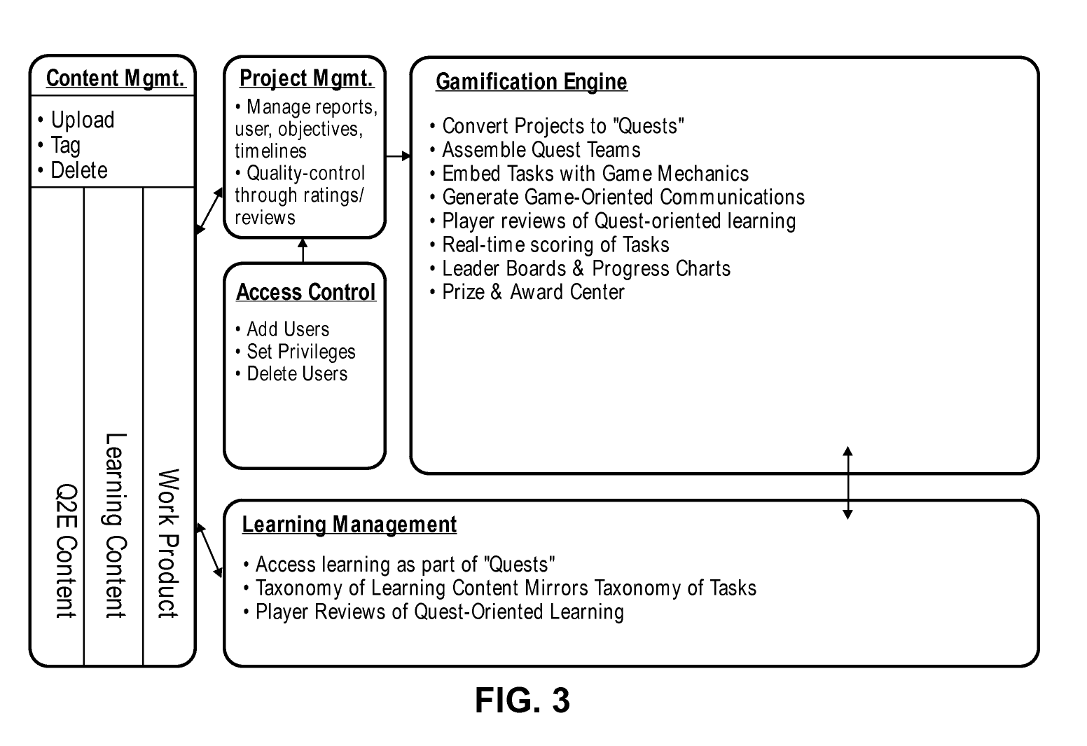

FIG. 3 provides a high level overview of some of the functions of individual components of the Quest2Excel system 200, in accordance with an embodiment of the present invention. The gamification engine converts project to Quests, assembles Quest teams, embeds Tasks with game mechanics, generates game-oriented communications, provides player reviews of Quest-oriented learning, provides real-time scoring of Tasks, provides leader boards and progress charts, and supports a prize and award center. The learning management system provides access to Task-related resources in a fashion that mirrors the taxonomy in Quests, and supports crowd-sourcing reviews of Task-oriented learning resources. The project management manages reports, users, objectives and timeliness, and provides quality control through reviews and ratings. Access control permits users to be added, the setting of privileges, and the deletion of users.

In one scenario, a choreographer (e.g., a consultant) aids in adapting a new business process/project into a Quest. This may include utilizing a library 203 of previous Quests, Mission, and Tasks and adapting the sequence of actions into a customized Quest for a particular business process. The Quest Master (Project Manager) is in charge of project management, and an administrator is in charge of access control. Individual players (End-Users) are typically workers (e.g., employees) of an organization (e.g., a business, although more generally the system may also be applied to government or non-profit organizations).

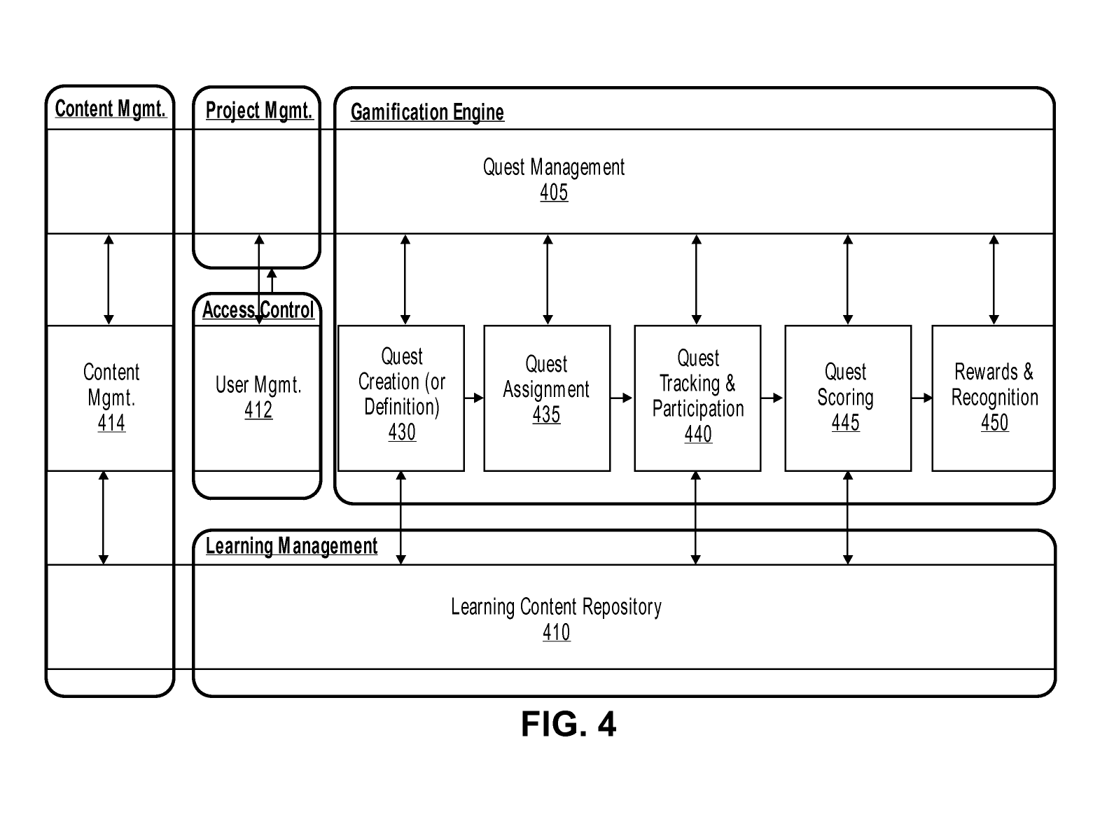

FIG. 4 is a block diagram of an example of how major functional blocks may be implemented in accordance with one embodiment of the present invention. A management layer “Quest Management” provides management functions for content management, project management, and the management of the game. The major blocks specifically supporting the gamification engine further includes a Quest creation/definition block 430, a Quest assignment block 435, a Quest tracking and participation block 440, a Quest scoring module 445, and rewards and recognition block 450. The system includes a learning content repository 410, content management 414, and user management 412. Additionally, monitoring and reporting features may be implemented either in individual blocks or across blocks to support dashboard for Quest managers and players to understand the status of a Quest, point counts of players, etc.

The gamification blocks illustrated in FIG. 4 supports organizing work effort into Quests, Missions, and Tasks, communicating openly and visually about the work effort, rewarding desired results and behaviors, and connecting specific work activities to a library of content and templates tailored to those activities.

Referring back to FIG. 4, the Core System is the main component that users will interact with as they carry out Reality-Enhanced Business Process Gaming. It is also the system used to access training needed to conduct those Reality-Enhanced Business Process Games.

The main activity of the Core System 200 is to enable End-Users to participate in “Quests,” which are reality-enhanced, gamified business-processes. Each main “Quest” is further subdivided into Missions, with Missions subdivided into Tasks. All of this is first accomplished in the Quest Creation 430 and Quest Assignment 435 components of the system.

In order to “Gamify” a business process, the system first allows for an Administrator or other Manager to first create the “Quests” (or games) that will be later played by others.

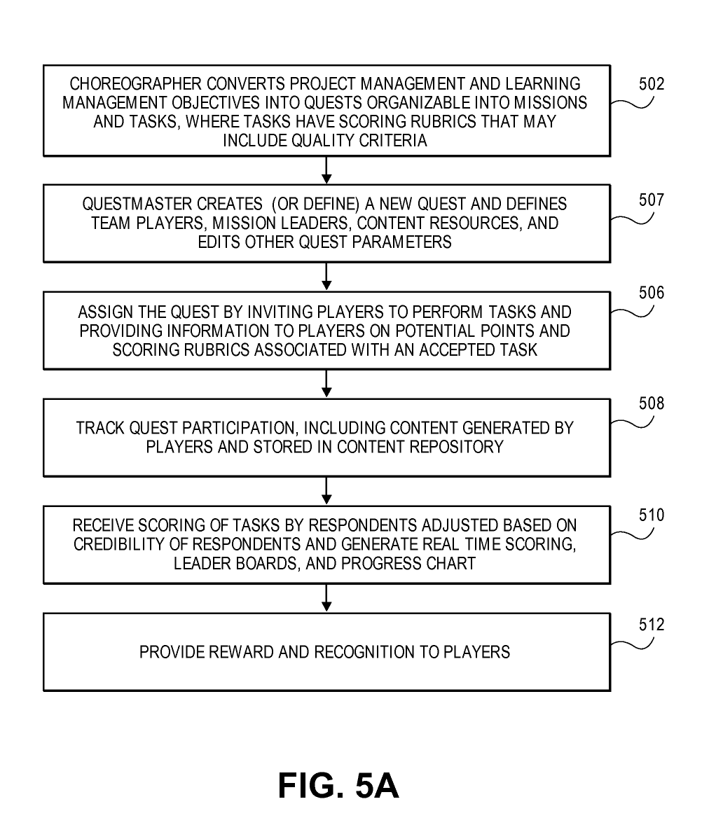

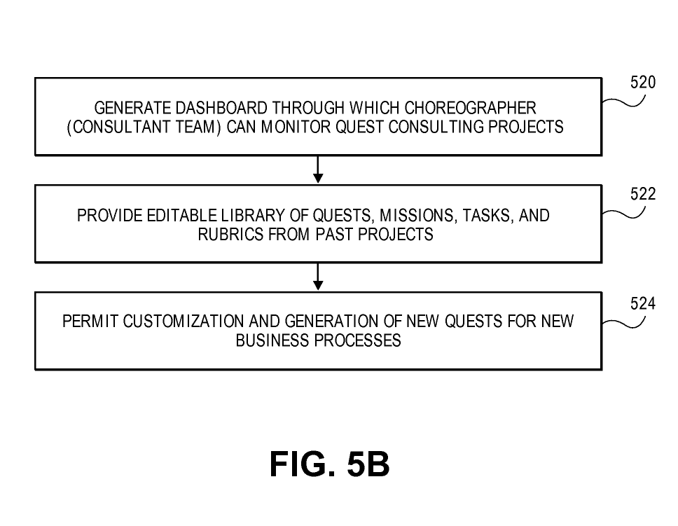

FIG. 5A is a flow chart illustrating a method of operation of a Quest. In block 502, a choreographer converts project management and learning management objectives into Quests organizable into Missions and Tasks, where Tasks have scoring rubrics that may include quality criteria. In block 504, the Quest Master creates (or defines) a new Quest and defines team players, Mission leaders, content resources, and edits other Quest parameters. In block 506, the Quest is assigned by inviting players to perform Tasks, and providing information to players on potential points and scoring rubrics associated with an accepted Task. In block 508, there is tracking of Quest participation, including tracking of content generated by players that is stored in a repository. In block 510, the scoring of Tasks by respondents is performed, including any adjustments made based on the credibility of the respondent. The scoring may be used to generate real time scoring, leader boards, and progress charts. In block 512, rewards and recognition are provided to players.

FIG. 5B is a flow chart illustrating a method for a choreographer to generate a type of Quest corresponding to a new type of business process. In block 520, a dashboard is generated through which a choreographer can monitor Quest consulting projects and, for example, determine if there is a new business process requiring the generation of new Quest features. In block 522, the choreographer is provided an editable library of Quests, Missions, Tasks, and rubrics, which may originate from past projects and/or include generic templates for common business objectives. As one example, the library 203 may be maintained in a storage unit on a secure server associated with the administration unit 201; however, more generally, the library unit and secure server could be maintained by a central choreography service. In block 524, access is provided to an individual choreographer to the library to permit customization and generation of a new type of Quest for a new business process, such as by adding, modifying, or deleting Missions, Tasks and Learning Options. After a new type of Quest is designed, it may be provided for use by the system 200. As previously discussed, an individual Quest may be designed to permit additional definition and customization by a Quest Master (e.g., selecting team players, attachments, Mission leaders, along with other optional selections within the bounds of the possible flows of individual Missions and Tasks designed into a new type of Quest by the choreographer).

Appendices A and B provide illustrative examples of business processes converted into Quests, Missions and Tasks. Additionally, options are provided to players to make the game more stimulating. It would be understood that many business face analogous problems in regards to training employees and pursuing generic issues such as marketing, product development, sales, etc. Consequently, over time a central choreographer service would generate templates applicable to the problems of specific industries that could be edited to create customized games for a particular company or organization.

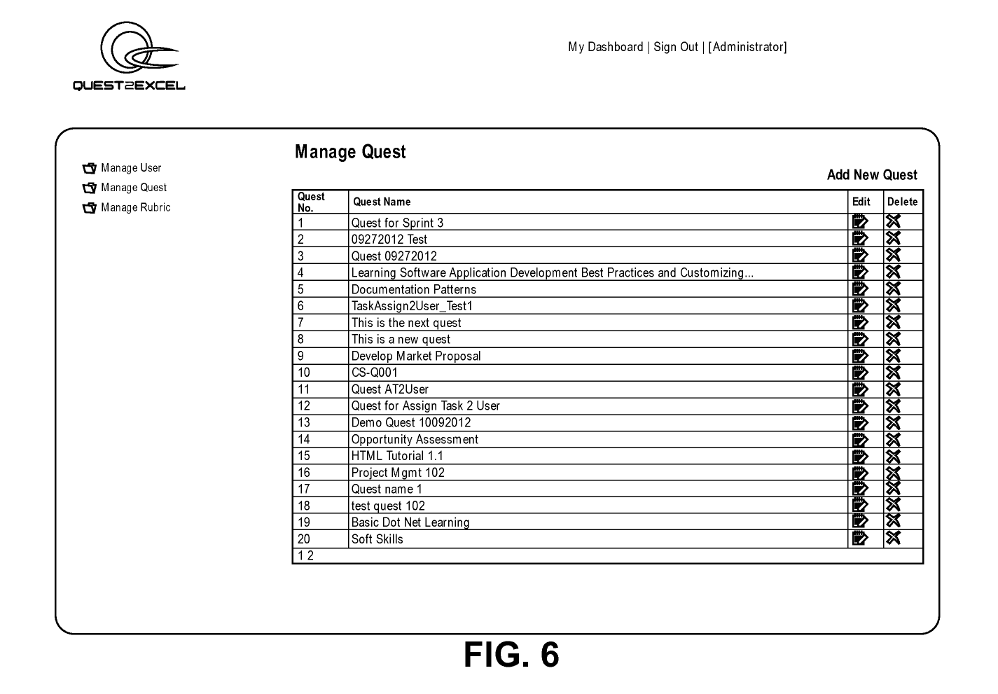

FIG. 6 illustrates a user interface for a Quest Master to manage Quests. The management interface displays a list of quests that are available on the system. In this example, the Quest include business projects (e.g., “develop market proposal,” “opportunity assessment”) and also business learning projects (“HTML Tutorial,” “Soft Skills”). The interface includes an “Add New Quest” button.

Quests—corresponding to major business processes—are created in the system when an individual (usually a Project Manager) creates a new Quest—accessing a screen listing all existing Quests in the company, and clicking on an “Add New Quest” button.

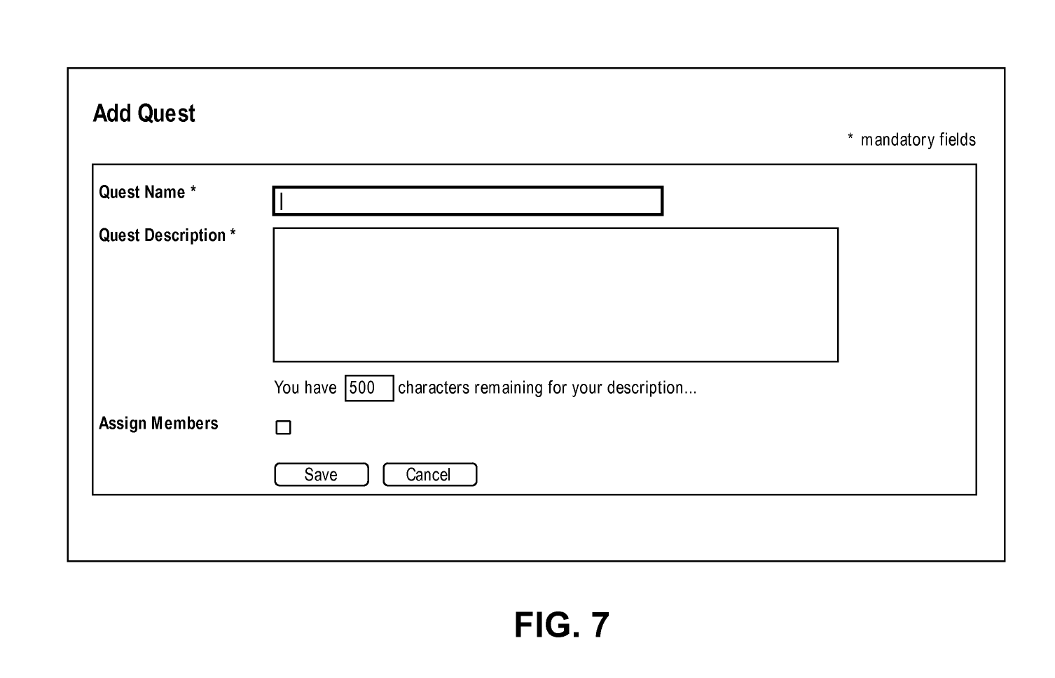

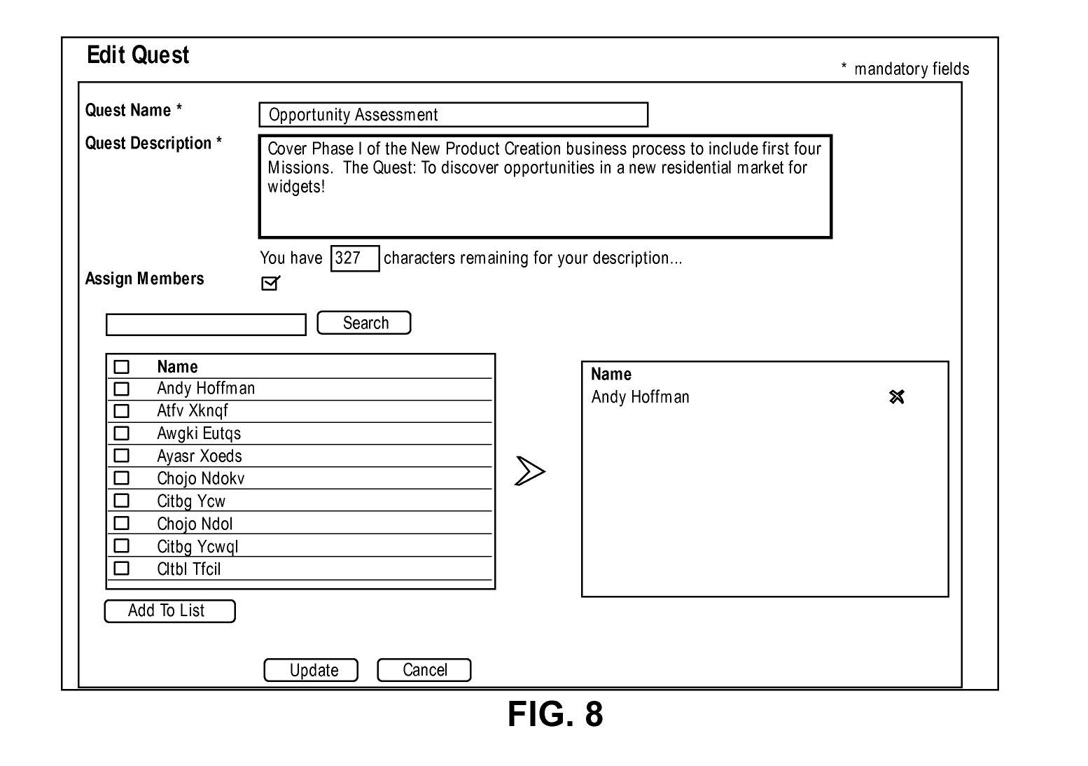

FIG. 7 illustrates a user interface to add a Quest that is displayed after a user clicks on the “Add New Quest” button. After clicking on the “Add New Quest” button, the Quest creator is taken to a new screen to fill out the details of that Quest, as illustrated in FIG. 8. The new Quest is given a name, description, and team members who will be assigned to “play” the Quest.

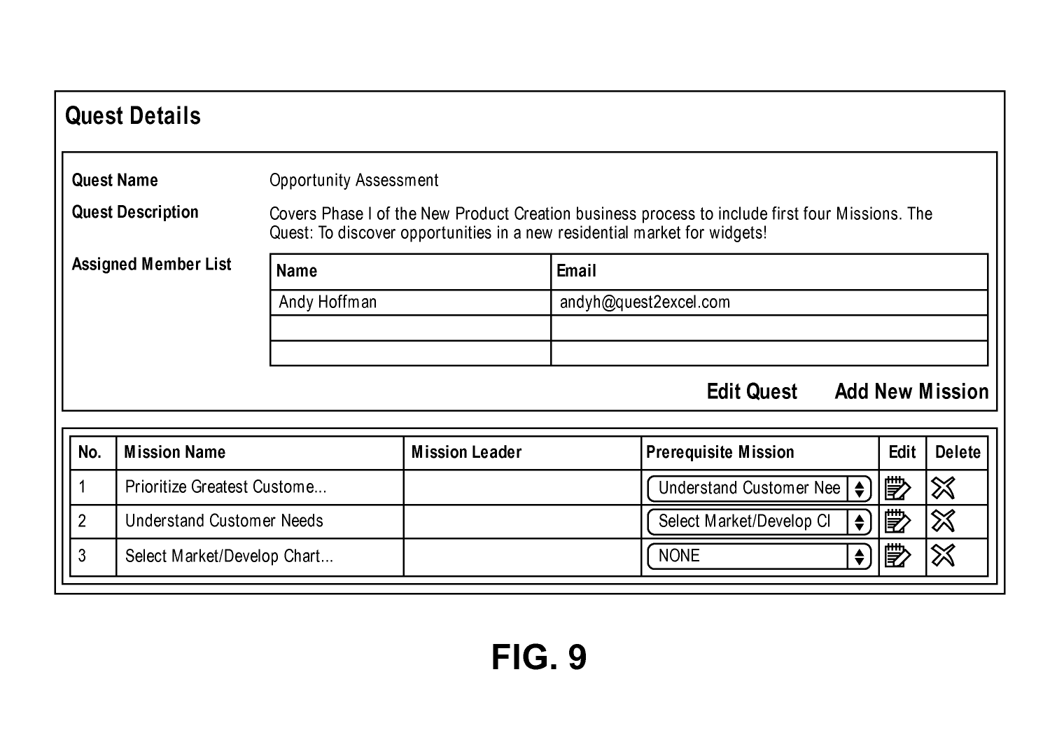

Once saved, the individual is presented with the Quest Details screen illustrated in FIG. 9. The Quest Details screen permits the individual to start adding “Missions” to each Quest. This is done by clicking “Add New Mission.”

A “Mission” is a major subcomponent of a Quest. If a “Quest” can be thought of as a major business process, then a “Mission” can be thought of as a discrete “Project” within that process. In a “Mission,” a team of individuals will seek to accomplish some specific objectives—usually some specific desirable business outcome.

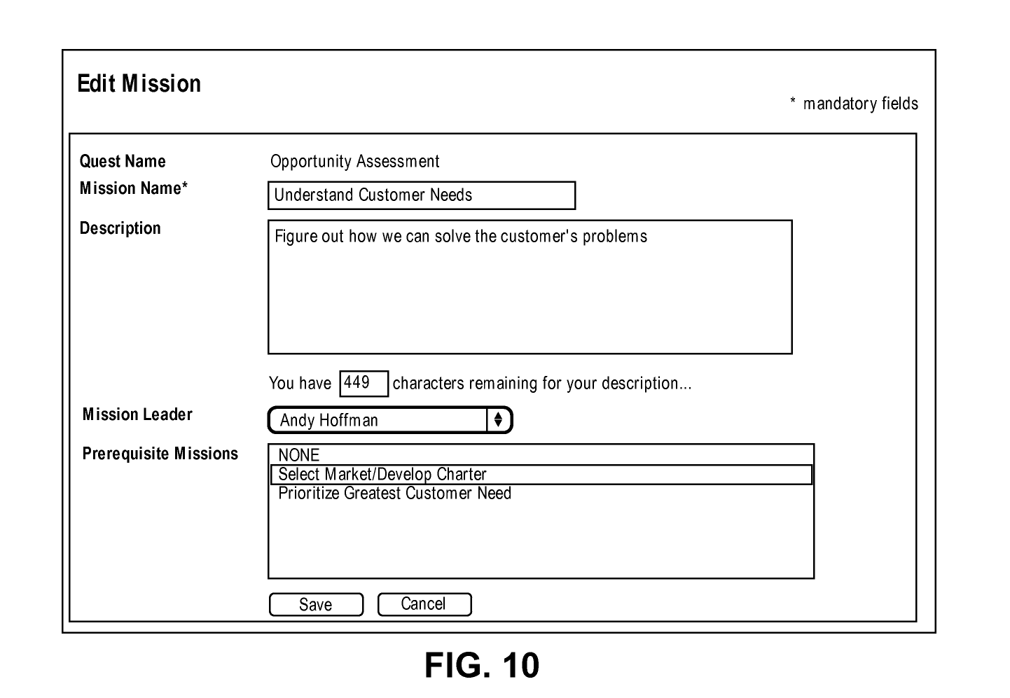

In this example, the Mission Team is going to be assessing a new Market opportunity for their company. After clicking “Add New Mission,” a Create/Edit Mission screen appears, as illustrated in FIG. 10. In this example, the Mission has a Mission name for the Quest, a description “Figure out how we can solve the customer's problems,” a Mission leader, and a list of prerequisite Missions.

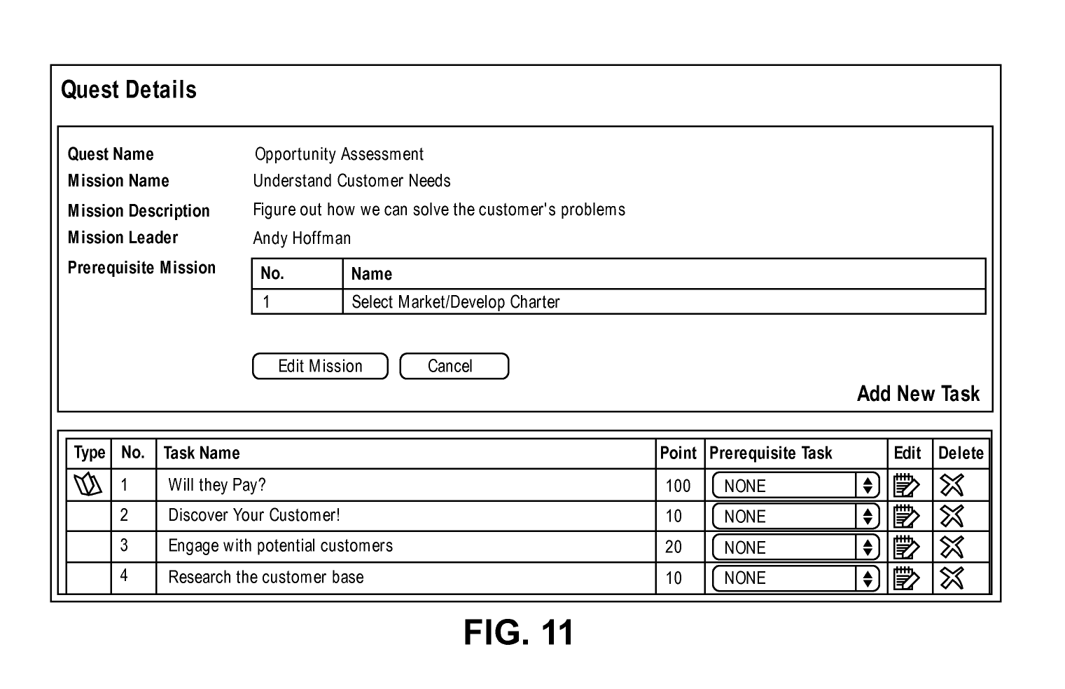

After filling in the Mission Details, the Mission is saved, and the User is taken to a Mission Details screen, which is illustrated in FIG. 11. In this example, a list of Tasks is presented (See, e.g., Appendices A and B for an example set of Tasks) where each Task has an associated point score. In this phase, it is time to create specific Tasks for each Mission—and it is in those Tasks that the “Gamified” nature of the Project itself is made manifest.

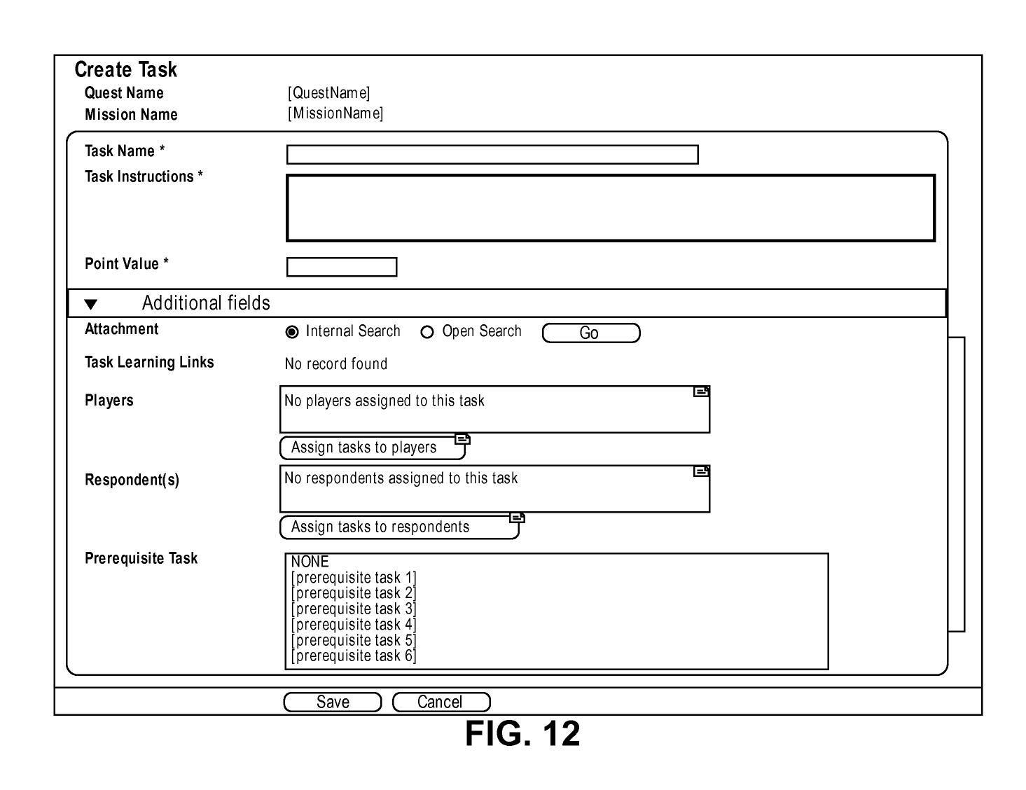

First, to add a new Task, the “Add New Task” button is clicked by a User. As illustrated in FIG. 12, the User can now add specific Tasks, where the Task has a Task name, Task instructions, and point value with additional field for attachments, links, players, respondents and prerequisite Tasks.

The Tasks themselves are framed as challenges for the User to carry out. They are “gamified” by assigning points that the player can earn for each Task assigned to them. Respondents (other individuals) are selected; they will later judge how well the Task was executed and how many points the players might earn for their completed Tasks. The administrator or manager clicks “Save” for each Task within a Mission.

Once a “Quest” is set up, users are invited to play the “Quest,” participate in team “Missions” within that Quest, and complete individual “Tasks” inside each Mission.

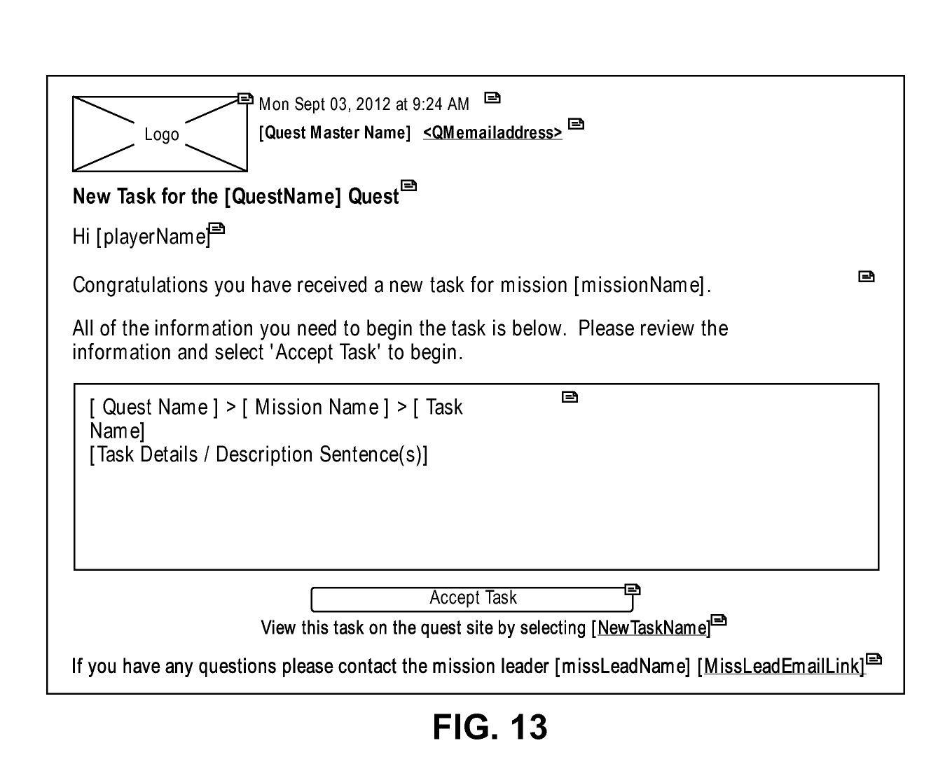

Referring to FIG. 13, for the player, the Quest first begins when users receive an e-mail message from the system, informing them that they have been made part of a “Quest” and assigned to a team “Mission,” and inviting them to participate in their first Mission “Task.”

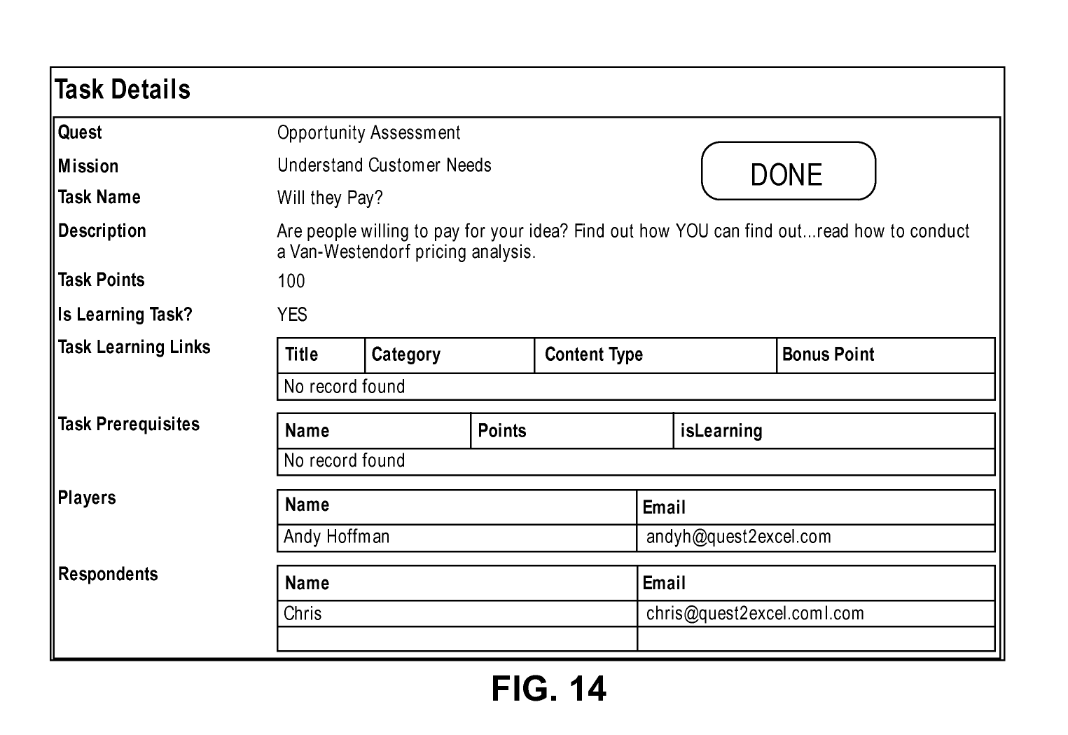

The player has the choice to either accept or reject a Task. If a player accepts the Task they are then taken to a “Task Details” screen showing them their next assignment as they continue to play the Mission. This is illustrated in FIG. 14. In this example, the player can earn a possible 100 points for executing a Task. In one embodiment, a player chooses one of the options for completing a Task and either goes to option details or selects a rejection button to signify that the player prefers not to accept the assignment. Providing a player with the option to reject a Task enhances the game aspect. For example, a motivated player may reject a Task in favor of a more challenging Task having a larger maximum point score. Additionally, providing options permits a player the option to select the Tasks that are most of interest to the player. For example, in some cases a larger objective can be achieved in more than one way. By providing a player with options to select Tasks the player can choose a Task based on their individual interests and the degree of challenge (as indicated by the maximum point count).

In one embodiment, a Task is mandatory. In another embodiment, a player has the option to select a Task during at least one phase of a Quest. For example, a player may select a Task that is more challenging and has more points. That is, in this embodiment, a player has a choice over which Task they accept as part of the game. Providing options to players to select Tasks from a set of Task options is a way to provide ambitious players options to take on more challenging Tasks and increase the mental and emotional stimulation provided by the game aspects.

After a player accepts a Task, the player then goes offline and conducts the “Task.” When done, they log back into the system, upload their completed work, and press the “Done” button to signal respondents that they should now assess the quality of the work.

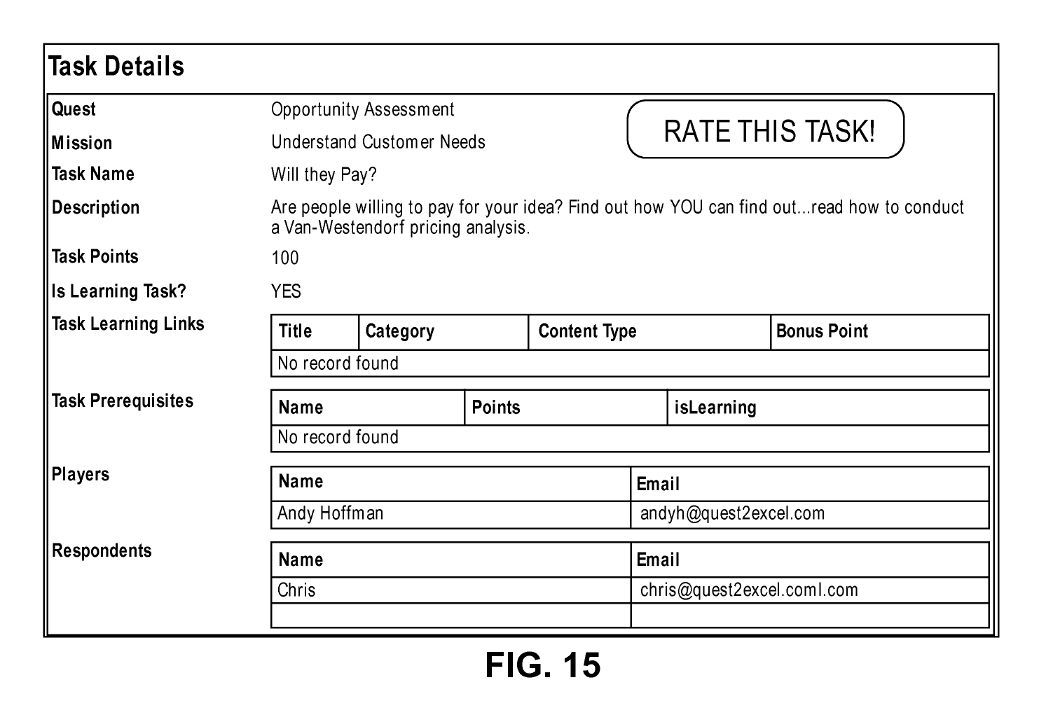

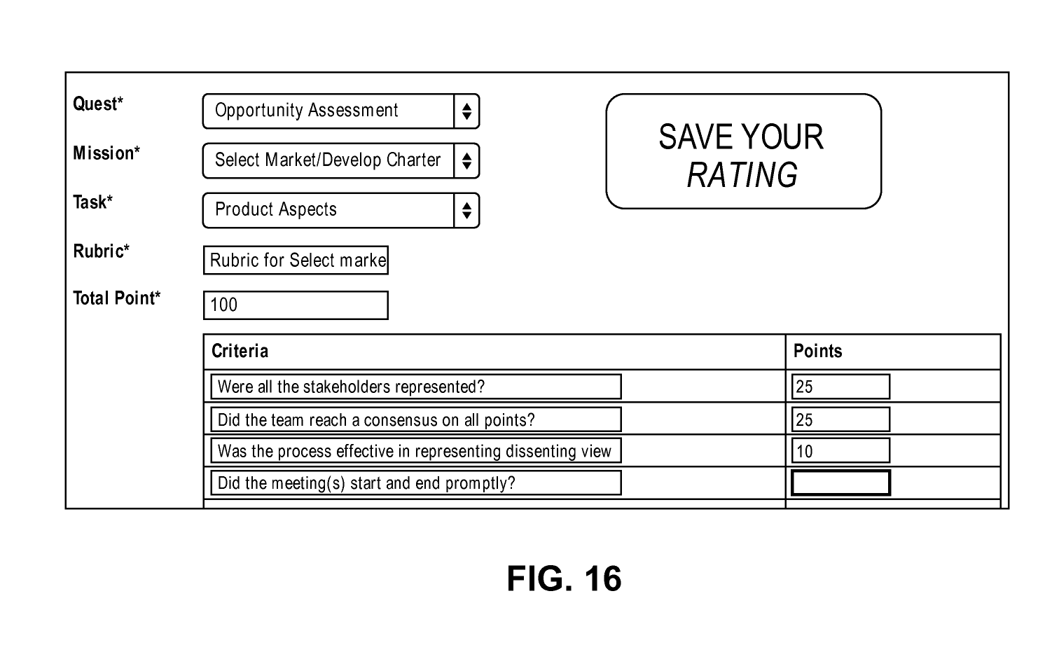

Respondents log in to the Quest2Excel system 200 and view the same Task, as illustrated in FIG. 15. They read any attachments. They then press a “Rate” button to access a grading rubric that has been set up for this particular Task, as illustrated in FIG. 16, which include criteria for the rating. In this example, the rubric for the Task includes four different criteria, each of which may be assigned points. Once the Respondent rates and saves any points for the Task, any Players assigned to that Task receive their points.

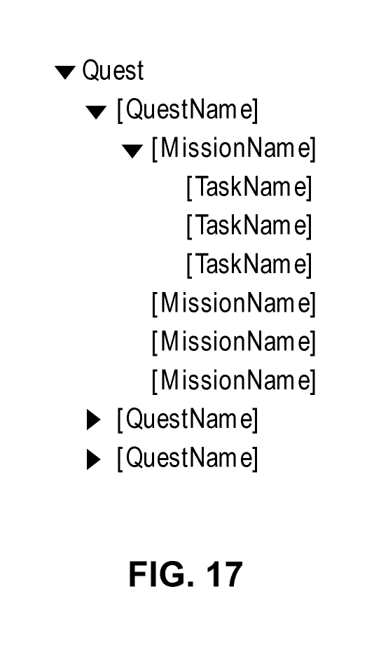

As Players play more “Tasks,” they accumulate more points. When all the “Tasks” in a “Mission” are competed, then that particular Project is considered complete. As illustrated in FIG. 17, each Mission has a set of Tasks and when all of the Missions are completed, the Quest is finished.

Along the way, Players are rewarded for completing groups of Tasks, or entire Missions, or achieving certain point levels, or completing certain difficult Tasks. The specific rewards are determined by the company using the system—but the “Gamification” component is the conversion of routine work into a series of fun interactions that ties periodic rewards to completion and accomplishment of specific Tasks.

Players (workers) complete Tasks. These Tasks are graded by assigned respondents against a pre-established, objective rubric. Points are stored and accumulated by the players based on this scoring.

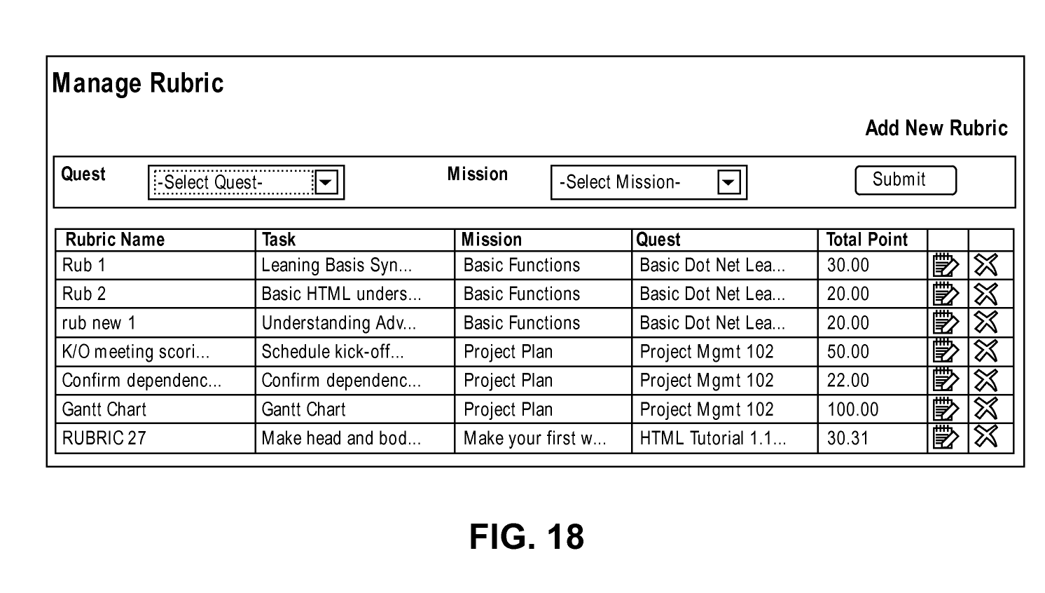

When a Task is created, the rubric for scoring completion of that Task is created and tied to the Task. FIG. 18 illustrates example of a screenshot of a user interface for managing rubrics. In this example, the user interface has a rubric for each Task of a Mission in a Quest. A summary of total points per Task is also provided.

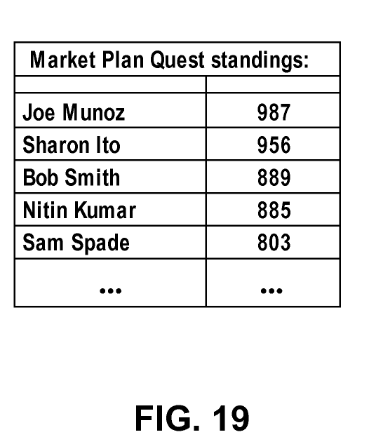

“Co-opetition” among employees is promoted by displaying scores for activities within projects. Co-opetition is the healthy blend of competition and cooperation, which is also sometimes described as “cooperative competition.” While performing work Tasks as part of the game environment, individual scores will be displayed. This will include both the points awarded for an individual Task, as well as the overall accumulated points by an individual, and compared to other individuals within a given project—a “leader board” as illustrated in FIG. 19, which illustrates a project specific leader board having point standings for a set of individuals working on a particular project.

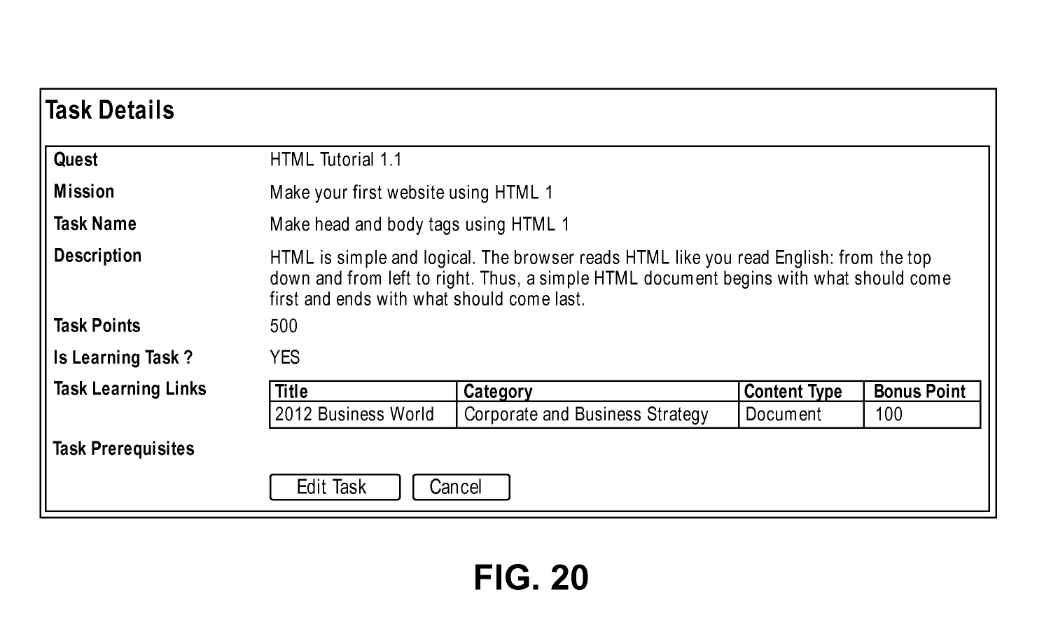

Learning is integrated into the game structure so that learning activities become valuable for employees at all levels of an organization. In one embodiment, Quests and Missions are created, and learning activities can be added as specific Tasks. This is illustrated in the screen shot of FIG. 20. In this example, the Quest is a HTML Tutorial, the Mission is to make a website using HTML, and the Task is a Learning Task. In one implementation, the user interface also provides a field to indicate that the Task is a Learning Task. Learning links can be included. Additionally, there are opportunities to learn even without having a dedicated Learning Task. For example, in one embodiment tools and templates are structured to provide opportunities to learn.

One aspect of the game design is that it can be used to build relationships of collaboration and mentorship into the fabric of an enterprise. Mentorship is provided through the scoring by respondents, as well as specific team Tasks.

In one embodiment, respondents are scored for their credibility in evaluating the players. A respondent's scores are based on such measures as player reviews and fairness of scoring (e.g. valuing response to work done at a commensurate level with the work itself). This credibility index can then be factored into the score given to players for individual Tasks.

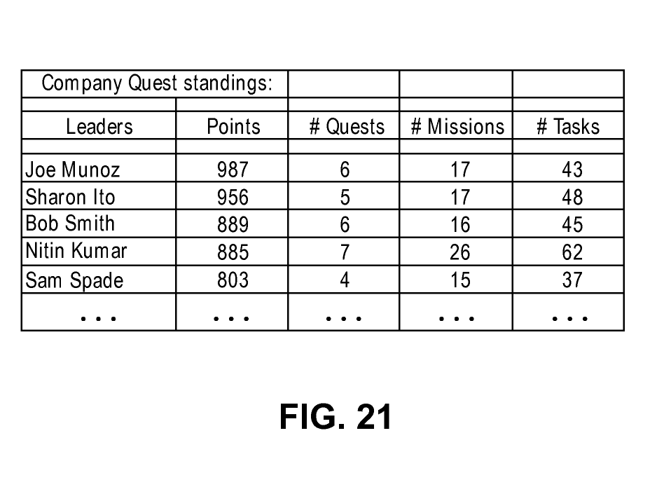

Leader-boards can also be maintained, both within a project and across the life of the organization, to reward consistently good work with higher levels of responsibility. In one embodiment, a leader board will be maintained for an extended time period that displays the accumulated scores and contribution to the organization. This is illustrated in FIG. 21, which shows pointers per player over a series of Quests, Missions, and Tasks to reflect company Quest point standings. As one example, the cumulative points per player could be accumulated over all Quests/Missions/Tasks for a given calendar period, such as per quarter or per year. Alternatively, the time period could be extended to be the life of the organization.

In one embodiment, the system allows organizations to include contrary-to-fact exercises within projects to which they relate—a change in cost-of-good in a product-pricing project, for example—to ensure project understanding and change preparedness. For example, a new Quest (or a Mission) can be defined, or an existing Quest modified, to support “what if” information. For example—do a Product Pricing Quest, with a doubling in cost of a key component.

In one embodiment, the system anticipated different work practices by adopting a methodology-agnostic system. Quests can be created for constituent Missions and Tasks to reflect the methodologies and processes of the creating organization. The Quest can be created from scratch, or an existing template can serve as a starting point. Particular Missions or Tasks within the template can be changed to reflect an organization's unique methodologies and processes, while retaining the Missions and Tasks that fit. Specific Learning Tasks can be added to enable Quest participants to learn the organization-specific methodology.

In one embodiment, there is automation, in substantial part, of a consultant's relationship with a client, allowing consultants to work simultaneously with many more clients than previously possible. A consultant can use a Quest as an automated means to provide the business process training or help with execution as required by an organization. The consultant can begin with standard Quest definitions. This saves the effort of defining Quests from scratch for each consulting engagement. These standard definitions can be modified based on his knowledge of the organization for which he is consulting. He can add, modify, or delete Missions, Tasks, and Learning Options. He can adjust points in the rubric to address specific areas of emphasis for the client. The hours needed to modify existing Quests will also be greatly reduced over supplying information to the organization specifically tailored to their needs. Also, access to relevant learning content (“how to” articles, tools and templates) during the execution of the Tasks will require less of consultant's time hand-holding or coaching those directly working on the Tasks. Hence the consultants and consulting organizations are able to work on more projects simultaneously thereby lowering the costs of operation.

In one embodiment, the system goes beyond assigning activities and noting deadlines, to storing the completed work products. As users participate in Quests by completing the individual Tasks assigned to them, the completion of those Tasks (and the overall progress of the Quest and “Missions” within the Quest) is tracked in the Quest Tracking & Participation component. This may include the uploading and tracking of completed work documents.

Many Tasks involve the creation of Work Documents specific to the business process being modeled by the Quest. If a Work Document is deliverable for a specific Task, Mission, or Quest, then the “Upload Complete Work Documents” function would be used by End-Users to store those completed documents into the core system.

One aspect of the present invention is that it permits the Quests to include a variety of options on how to complete work activities. These options may include features that embrace the motivational aspects of play and games, thereby increasing productivity. The increased motivation also sparks a player's interest in performing their option at a higher level through learning, collaboration and mentorship, each of which contributes to the positive feedback motivation of scores an rewards. The present invention may therefore be used to create a virtuous cycle of playful work, rewards for pro-social behaviors, increased motivation and productivity.

The Core System 200 supports Augmented Reality Gaming (ARG) of a Business Process. The main activity of the Core System is to enable End-Users to participate in “Quests,” which are reality-enhanced, gamified business-processes. Each main “Quest” is further subdivided into Missions, with Missions subdivided into Tasks. Tasks are designed to be enjoyable to complete, and a sense of being in a game is enhanced through scoring of those Tasks.

Scoring is key to game play. Without a clear sense of how a player is doing within a game context, the activities are no longer a game; they are just work. Players must not only see their score: they must understand how the score relates to their activity; recognize a correlation between their scores and the value the enterprise places on their activity; and see their score in relationship to other people's scores. The Quest Scoring component 445 is where completed Tasks are rated and scored, and where cumulative points are stored for the ongoing Missions and Quests.

By adding respondents to each activity, the system tracks the quality of the content of work products as completed instead of just noting their completion. The Quest Scoring component 445 is where completed Tasks are rated and scored, and where cumulative points are stored for the ongoing Missions and Quests. Some of the key functions of Quest Scoring, as they relate to this quality, are (1) Peer Task Review, and (2) Peer Scoring by Rubric. The “Peer Task Review” (or Reviewer) function allows individuals designated as Reviewers the ability to provide feedback, commentary, and review for each completed Task. (This is to facilitate the Learning function of the Tasks themselves). The “Peer Task Review” function also allows individuals designated as scorers the ability to rate each completed Task according to the Scoring Rubric for each Task. (See Quest Creation above).

The system 200 supports collaboration and mentorship by creating team responsibilities for activities and having respondents review each activity. Once Quests are created, they are assigned to teams of End-Users who will carry out the Tasks and complete Missions within the Quest. The Assignment of End-Users to Tasks and Missions is carried out, when (1) Quest Teams are created, and (2) Quests and Missions are assigned to those Teams. Once Individuals and Teams complete their work, the completed activities are reviewed by respondents through the Scoring process: Respondents will review the completed activities and score them using a Rubric to assess and score those activities.

Additionally the scoring of Task may be used for talent assessment. The point counts on individual Tasks, Missions, and Quest may be analyzed to assess the relative talents of players in specific areas. As an illustrative example, suppose that one player has higher point scores on a specific type of business development related Task or Mission. This information can be used to identify that the employee has a specific talent, relative to other employees. Thus, in one embodiment the point scores are correlated with talent areas to support talent identification, talent based reviews, and talent-based ratings.

The integration of learning management 206 with the system increase the value of learning within a project itself, by including Learning Tasks and Learning Options among activities that the system collects and rates. For example, when Quests (and Missions and Tasks) are created, some of the Tasks will be designed to encourage users to go out and learn how to do a particular activity (or to acquire some new skill)

Further, some “Tasks” will have specific Training Content linked to that Task; to enable End-Users to learn how to conduct “Tasks” they may be unfamiliar with.

The system 200 permits assigning scores in a timely way to each activity within a project, so Project Managers can identify weak links along the way; and once Individuals and Teams complete their work, the completed activities are reviewed by respondents through a Quest Scoring process.

Respondents will review the completed activities and score them using a Rubric to assess and score those activities. Once activities are scored, a Completion Monitoring function occurs through the Quest Management console's ability to view overall Quest Scoring and Reviews. The core functions of Completion Monitoring are (1) Viewing Accumulated Points, and (2) Receiving Completed Reviews.

A “View Accumulated Points” function allows Managers and Administrators to see how many points have been accumulated to individuals and teams for the completion of their Tasks.

A “Receive Completed Reviews” function will send Managers Task reviews as those reviews are completed; the function will also allow Managers to see all reviews received by individuals and teams.

In one embodiment, the system 200 tracks scores so that Managers know employee strength and weaknesses, project to project. In the “Cross-Quest Scoring” function, Managers will have access to Cross-Quest scoring data. Such data will be used to enable a variety of activities. For example, Project Managers can use “Cross-Quest Scoring” to pick team members based on their total score for all Quests so that they can build the strongest team possible. “Cross-Quest Scoring” may also provide score access by non-participants—Project Managers accessing a pool of trained people. An “Individual Scores & Status” function provides a managerial view of scores individuals have received, as well as their current status within a Quest (i.e. which Mission and Task they are currently on).

In one embodiment, an “Analytics” function will analyze different types of Quests (corresponding to different business functions), and identify those with productivity or completion challenges, enabling managers to focus on improving problem business processes.

The system extends learning management systems by integrating work and learning at each stage of a project. In a typical enterprise environment, a significant percentage of the Tasks may be Learning Tasks—finding and reading valuable articles and book, attending training, interviewing a co-worker with different responsibilities, posting a relevant video, or the like. In one embodiment, Learning Tasks will be marked separately, with a gold border for example, and always open to everyone within the department(s) responsible for the project. Learning Tasks can also be designed to relate directly to the work at hand.

One aspect of the system is that it provides a socially networked platform through which employees can see the growth of one another's knowledge, skills and abilities. Individuals assigned specific Tasks have their Tasks scored, as described earlier. All individuals accumulating scores as part of a Mission and Quest team—in effect, are connected to each other through their team, which was created as part of the Quest.

Private scores for players will allow players to compare themselves against personal benchmarks and review their progress and developing skills. Public scores for players may be calculated using a formula that shows progress and growth, but which in a gaming sense will always be relatively close (to avoid people deciding not to play because, for example, some other team member has already completed 15 tasks and has achieved a seemingly unreachable scoring level). Public presentation of achievement might also include the number of completed tasks and the importance of tasks within a Mission or Quest. Presentation screens allow players to clearly compare their performances.

One aspect of the system is that it permits attaching value to learning, in the form of scores on rubrics that include timeliness and relevance, through a system of responses to each Learning Task or Learning Option. When a Learning Task is created, a rubric is created and associated with that task. For example, all rubrics will have measures for timeliness and completeness. Some rubrics will also assess creativity, relevance, or effectiveness.

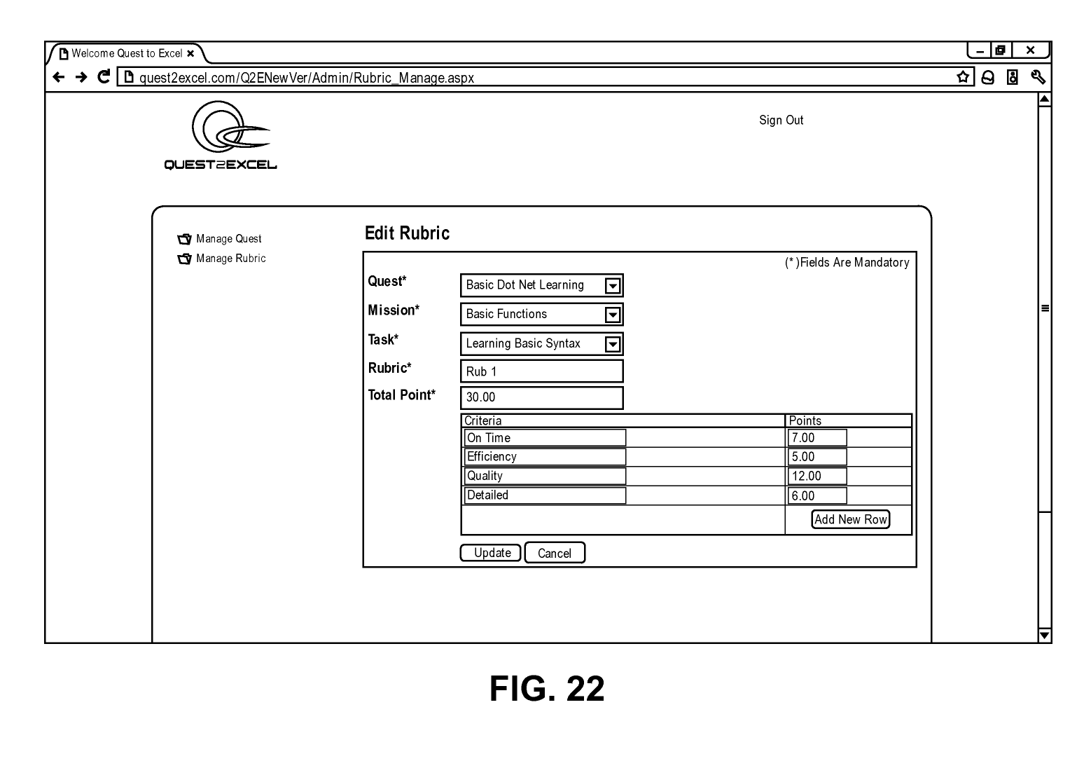

FIG. 22 illustrates an example for a task “Learning Basic Syntax” having a rubric “Rub 1” with points provided for on time, efficiency, quality, and detail. All rubrics should follow the same format, and they will very similar.

As previously discussed, in one embodiment the system 200 establishes a Credibility Index that rates the reliability of a respondent's scoring. Respondents are assigned to review completed Tasks through the scoring mechanism already described. In one embodiment, thoroughness, timeliness and reliability of Respondents' assessments will form a Credibility Index. Everyone begins with a Credibility Index of 100, and that number goes up and down based on their performance as Respondents. A Respondent who always rates everything 5 loses credibility, just as one who scores everything 1 or 3. The index can measure variation in scores over time as a rough approximation of the Respondent's thoroughness. In the end, a player's score will be multiplied by the Respondent's Credibility Index. A high Credibility Index will always result in a slightly higher score for the player.

In one embodiment, the scoring system is used to rate the learning value of the content within the system. Some Learning Tasks will assign players the job of finding or creating Learning Content and saving it within the Learning Content Repository. At the completion of such Tasks, the already described Rating and Review process will rate the content thus stored.

In one embodiment, the system is used to develop a source-agnostic system of content delivery. The Content Management component 414 of the system is used to manage a Learning Content Repository 410 used on Quests, Missions, and Tasks.

The Learning Content Repository 410 is used to store high-quality training in a variety of formats (documents, audio, video, interactive assessments)—training to be accessed later in the context of playing the reality enhanced game while executing particular Task in their business process (or Quests). It will provide a library of proprietary, licensed and open-source learning content and associated templates, tools and applications.

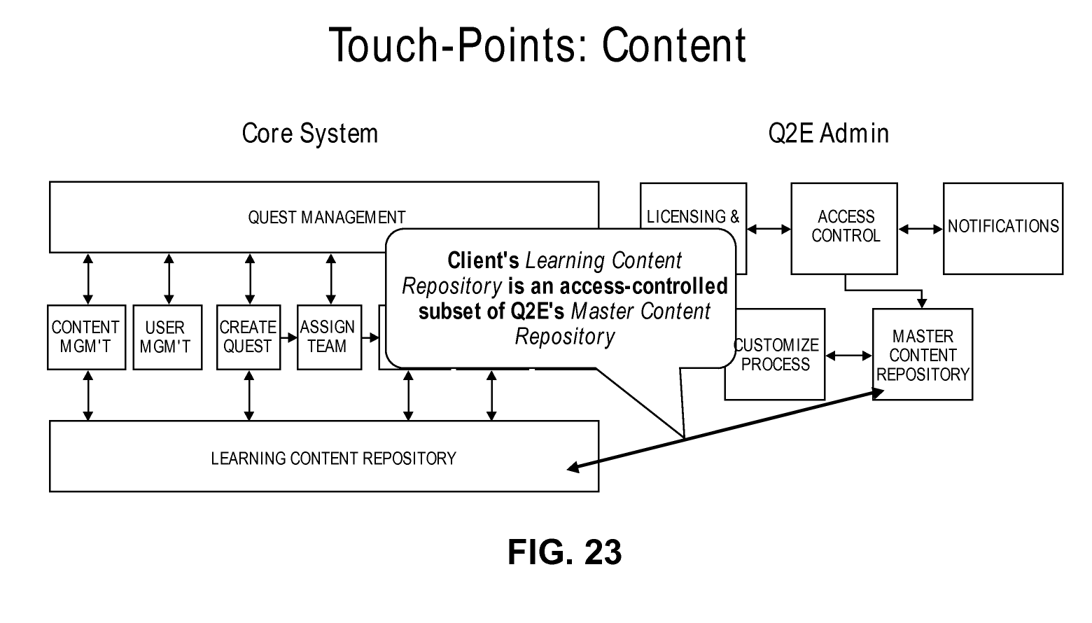

In one embodiment, the system extends content management systems by opening the content management system to uploading work product from within an enterprise, as well as content from or for organizations beyond an enterprise's walls. Referring to FIG. 23, the client's learning content repository may be implemented as an access-controlled subset of a master content repository of a larger administrative complex. As Tasks are completed, their work products are uploaded to the Learning Content Repository.

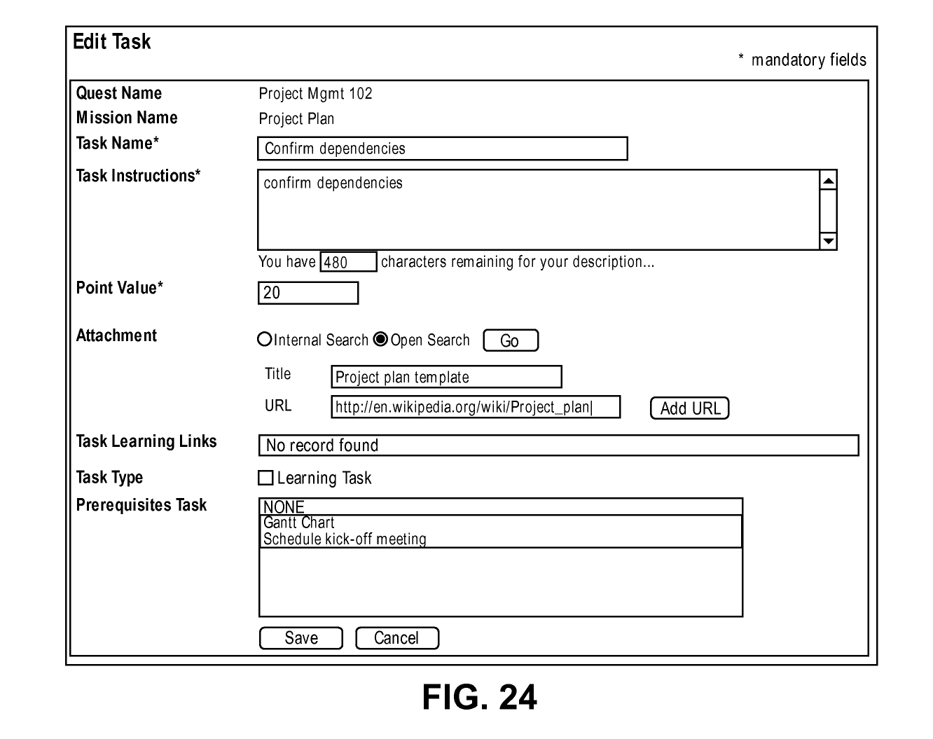

In addition, content from the internet can be specifically searched for and attached to Tasks. This is illustrated in FIG. 24, which illustrates URLs (in this case a link to a site on Wikipedia) attached to a Task.

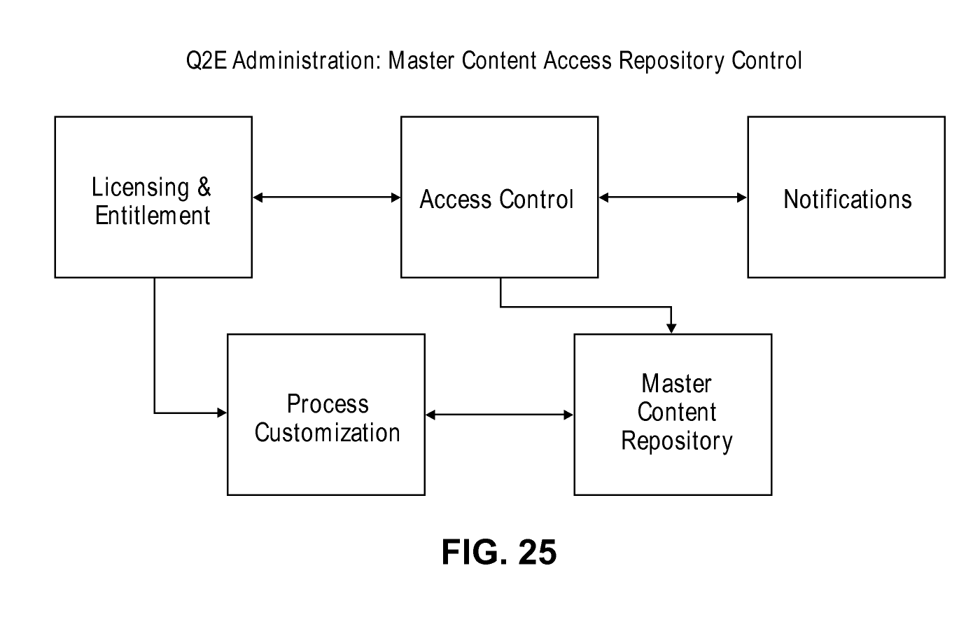

The system also supports developing a new system of privileges to allow the right people access to appropriate content and blocking others. Access to content can be by organization, Quest team, role, or individual. FIG. 25 illustrate master content repository access control within an administrative complex.

### Summary of Selected Innovative Features and New Functionalities

The system provides many new functionalities not previously possible, which may be used individually or in combination. Moreover, the system permits fundamentally new ways of working and new types of interactions between consultants, managers, and workers. That is, the integration of project management, learning management, content management, and an augmented reality game supports features, functions, and ways of working that previously would not have been possible. A partial summary of some of the innovative features, functionality, and new ways of working is provided below.

### A. New Workplace Management

The system provides an innovative combination of project, learning and content management software systems into a game environment that innovates the workplace through one or more of the following:

1) turning the specific activities of work into a playful and productive game through a system of respondents, rubrics and scoring, thus making the work activities more fun and enjoyable;
2) integrating that scoring with work and learning at each stage of any project;
3) promoting “co-opetition” among employees by displaying scores for activities within projects;
4) integrating learning into the game structure so that learning activities become valuable for employees at all levels of an organization;
5) building, through game design, relationships of collaboration and mentorship into the fabric of an enterprise;
6) valuing response to work done at a commensurate level with the work itself, by including a player's Credibility Index in his or her total score;
7) maintaining leader-boards both within a project and across the life of the organization, to reward consistently good work with higher levels of responsibility;
8) allowing organizations to include contrary-to-fact exercises within projects to which they relate—a change in cost-of-good in a product-pricing project, for example—to ensure project understanding and change preparedness;
9) anticipating different work practices by adopting a methodology-agnostic system; and
10) automating, in substantial part, a consultant's relationship with a client, allowing consultants to work simultaneously with many more clients than previously possible.

Note that the system goes beyond conventional project management software by supporting one or more of:

1) going beyond focus on scope, schedule and budget to include controls over quality of work output;
2) providing an intrinsic system for rewarding desirable behaviors;
3) going beyond assigning activities and noting deadlines to storing the completed work products;
4) creating activities that are more fun, dynamic and involving the standard work activities;
5) adding respondents to each activity, so that system tracks the quality of the content of work products as completed instead of just noting their completion;
6) supporting collaboration and mentorship by creating team responsibilities for activities and having respondents review each activity;
7) valuing learning within the project itself, by including Learning Tasks and Learning Options among activities that the system collects and rates;
8) assigning scores in a timely way to each activity within a project, so Project Managers can identify weak links along the way; and
9) tracking scores so that management knows employee strength and weaknesses project to project.

Additionally, the system goes beyond conventional learning management systems by supporting one or more of:

1) integrating work and learning at each stage of a project;
2) designing all Learning Task to relate directly to the work at hand;
3) creating a socially networked platform through which employees can see the growth of one another's knowledge, skills and abilities;
4) attaching value to learning, in the form of scores on rubrics that include timeliness and relevance, through a system of responses to each Learning Task or Learning Option;
5) establishing a Credibility Index that rates the reliability of a respondent's scoring;
6) using the scoring system to rate the learning value of the content within the system; and
7) developing a source-agnostic system of content delivery.

Moreover, the system extends content management systems by supporting one or more of:

1) tying content to work processes so that employee can easily find resources relevant to their immediate work needs;
2) opening the content management system to uploading work product from within an enterprise, as well as content from or for organizations beyond an enterprise's walls; and
3) developing a new system of privileges to allow the right people access to appropriate content and blocking others.

### B. Increasing Consultants' Efficiency

Businesses hire consultants, at a high cost to the tune of approximately $75,000,000,000 annually. In most cases, a single consultant can only work with a single company or a project at a time. Sometimes, consultants are hired because the company does not have a required skill set in-house, or to solve a short-term project, such as a research study. Just as often, a company hires a consultant to resolve a knotty work process, to deal with a problem they would rather not handle themselves, or because they perceive a problem, but do not know its cause or its solution. For these purposes, the system provides consultants with a new and highly effective toolset.

A consultant would employ the system provider to address these problems, working closely with our choreographer, or perhaps becoming a choreographer for a Quest. Because of the capacity of the system to manage business process, offer transparency in all aspects of the process, and motivate and reward positive behavior, a consultant can use the system to quickly develop a better work process, and monitor and alter behavior and knowledge of the employees engaged in the Quest's Mission and Tasks. What might have occupied several consultants full-time for several months, now can be handled by a single consult on perhaps a half-time basis or less. This increased efficiency, matched with our behavior analysis and control mechanisms, will help consultant not only produce better results with less effort, but also provide better and more timely measures of their success.

The system makes this possible through:

1) a dashboard through which a consult can monitor several Q2E consulting projects simultaneously;
2) a set of Quest-specific tools that allow the consultant to work hands-on with a client in managing a specific work process;
3) a simply way to provide consultants with the blend of interventions most useful for a particular client, whether improving communication or uncovering sabotaging employees;
4) a library of Quests, Missions, Tasks and Rubrics that have been tested and proven effective with prior clients; and
5) a capacity to change old or invent new processes as circumstances require.

### C. Content Providers

The system offers business content providers unprecedented access to consumers. The current market for content requires businesses to buy access to a large library of content and then provides idiosyncratic finding tools disassociated from the actual work processes, making it difficult and time-consuming for employees to find relevant content quickly, as they work on a specific Task. Additionally, providers offering off-site training have found the market for their offerings dwindling, because their service is costly, not only for the training but also in lost productivity. Overall, the $8,000,000,000 annual training industry has—like many content providers in other fields—found itself struggling with how to make their assets valuable in the digital landscape.

The system will open channels directly to businesses and their employees. Whether top-flight graduate schools offering distance-learning MBA programs or purveyors, of brief focused content on aspects of marketing or technology, providers want to gain access to potential customers just when they are working on a Task which their content might address successfully. Using the system's proprietary taxonomy to connect content to work activities, content providers will be able to connect with customers as never before. The system will also be able to monitor use and relevance of certain content to certain Tasks, making certain that enterprises know when they are getting the best possible training for their employees.

While the invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Additionally, those of ordinary skill in the art will recognize that a variety of wired or wireless devices having an interactive display may be used, including smartphones, tablet devices, computers or other devices having an interactive display. The present invention may also be tangibly embodied as a set of computer instructions stored on a computer readable medium, such as a memory device.

APPENDIX A
New Product Development - Idea Generation and Development

| | Task | | | | |
|---|---|---|---|---|---|
| Mission | Grouping | Task | Option | Task Rubric | Option Rubric |
| Customer | | Define | Make a powerpoint | 1) How effectively did the | 5) How effective is the player's |
| Behavior | | the Pain | presentation of the | player analyze the | powerpoint of the specific pains? |
| and Needs | | | possible specific pains | consumer pain points? | |
| Study | | | that a consumer could | 2) Was the player | |
| | | | experience. | successful in selecting the | |
| | | | Send three tweets to the | most pertinent customer | 5) How clear and concise was the |
| | | | Mission team, | pain points? | player in the tweets he/she |
| | | | identifying the three | 3) How effective was the | composed? |
| | | | most pertinent customer | player in communicating | 6) How effectively was the player |
| | | | pain points. | his/her research? | in getting the rest of the team able |
| | | | | 4) How comprehensive | to understand the most pertinent |
| | | | | and thorough is the data | pain points that the player |
| | | | | the player has to back up | identified? |
| | | | | their pain points? | 7) How effectively did the tweets |
| | | | | | communicate the key findings of |
| | | | | | the research? |
| | | | Create a comic strip for | | 5) How creative was the player in |
| | | | each of the top three | | making the comic strips? |
| | | | customer pain points. | | 6) How effectively did the comics |
| | | | | | communicate the key findings of |
| | | | | | the research? |
| | | Define | Find a customer's | 1) How detailed was the | 4) How clear and concise was the |
| | | the Job | primary, secondary, and | player's analysis of the | player's analysis of the customer's |
| | | to be | tertiary Jobs to be Done - | customer's jobs to be | primary, secondary, and tertiary |
| | | Done | what the customer | done? | Jobs to be Done? |
| | | | wants to accomplish | 2) How effectively did the | 5) How successful was the player |
| | | | using the product | player step into the | in selecting the most important Jobs |
| | | | | customer's shoes to | to be Done for the selected market? |
| | | | | conduct his/her research? | |
| | | | Pretend you are the | 3) How creative was the | 4) How effectively did the player |
| | | | customer trying to | player in presenting or | understand the customer when |
| | | | accomplish this JTBD, | framing his/her findings? | evaluating the customer's options? |
| | | | and evaluate existing | | 5) How detailed was the player's |
| | | | solutions. | | analysis of existing solutions for |
| | | | | | the customer's JTBD? |
| | | | Video record 5 | | 4) How detailed were the player's |
| | | | customers completing | | interviews with the 5 customers? |
| | | | their job to be done | | 5) How unique are the 5 customers |
| | | | (JTBD). Would they pay | | the player records? |
| | | | for a new, better solution | | |
| | | | for this JTBD? | | |
| | | Define | Based on your | 1) How well does the | N/A |
| | | Measurement | determination of the Job | player incorporate the | |
| | | of Success | to be Done, identify the | specific Job to be Done? | |
| | | | top measurements of | 2)How well does the | |
| | | | success of a pain killer | player rank the top | |
| | | | Talk to customer support | measurements of success? | N/A |
| | | | and sales people within | 3) How specific are the | |
| | | | your company to see | measurements of success | |
| | | | how customers tend to | to the specific JTBD | |
| | | | measure the success of | determined in the previous | |
| | | | current pain killers | task? | |
| | | | Interview 5 customers to | | N/A |
| | | | determine their top | | |
| | | | measurements of success | | |
| | | | of a pain killer | | |
| | | Identify | Ask industry analysts | 1) How creative were the | 5) How significant an effort did the |
| | | New | about potential pain | player's potential pain | player make to reach out to |
| | | Potential | killers and submit the | killers? | industry experts? |
| | | Pain | most important and | 2) How effective are the | 6) How diverse was the player's |
| | | Killers | effective ones you | solutions and addressing | search? |
| | | | found. | the pain points? | |
| | | | Find three feasible but | 3) How effective are they | 5) How novel were the player's |
| | | | novel approaches to | in helping the consumer | ideas? |
| | | | solving the pain and | accomplish the Job to be | 6) How feasible would the player's |
| | | | describe them | Done? | solutions be in the “real world”? |
| | | | Conduct interviews with | 4) Were all of the success | 5) How detailed were the player's |
| | | | customers to see what | measures taken into | interviews with the customers? |
| | | | they would like to see as | consideration? | 6) How comprehensive was the |
| | | | a new solution to select | | information gathered from the |
| | | | customer pain points. | | customers in order to develop an |
| | | | | | effective solution? |
| Concept | Contextual | Conduct | Why choose this | 1) How effectively and | 4) How effectively does the player |
| Development & | Analysis | Industry | industry segment for the | efficiently does the player | directly compare each industry to |
| Testing | | Analysis | new product over | answer all parts of the | show the benefits and |
| | | | others? | question? | disadvantages of choosing each |
| | | | | 2) How well does the | market? |
| | | | | player understrand the | 5) How effectively does the player |
| | | | | industry? | defend the choice of this industry |
| | | | | 3) Does the player show | segment? |
| | | | What are the strengths | what resources/sources | 4) How well does the player |
| | | | and weaknesses of major | they used to come to their | identify the major players? 5) How |
| | | | players in this industry | conclusions? | comprehensive is the player's |
| | | | segment? | | perform comprehensive stength and |
| | | | | | weakness analysis into each |
| | | | | | competitor? |
| | | | Build a timeline out to | | 4) How well has the player told the |
| | | | show industry trends and | | story of the industry and its |
| | | | breakthroughs over the | | relevant discoveries and |
| | | | past 10 years | | breakthroughs? |
| | | | | | 5) How clear and creative is the |
| | | | | | player's timeline? |
| | | | Project the direction this | | 4) How well does the player use the |
| | | | industry will go in over | | past to identify possible future |
| | | | the next 3 years. | | trends? |
| | | | | | 5) How thoroughly does the player |
| | | | | | back up projections with research? |
| | | Conduct | Analyze the | 1) How comprehensively | 3) How well does the player |
| | | Market | opportunities each | does the player address | segment the market? |
| | | Analysis | market segment provides | and analyze the market? | 4) How thoroughly does the player |
| | | | the company. | 2) How sensitively does | analyze the market opportunities? |
| | | | | the player address and | 5) How sensitively does the player |
| | | | | analyze the market? | identify the potential benefits of |
| | | | | | those opportunities? |
| | | | Conduct a SWOT | | 3) How completely does the player |
| | | | analysis of the | | identify the major competitors and |
| | | | competing products in | | their market share? |
| | | | this market including | | 4) How comprehensively does the |
| | | | recent performance. | | player conduct the SWOT analysis |
| | | | | | of the products? |
| | | | How might the size of | | 3) How persuasive is the player's |
| | | | your Total Addressable | | projection? |
| | | | Market (TAM) change | | 4) How well does the player justify |
| | | | over the next 5 years? | | their conclusions with research and |
| | | | | | personal experience? |
| | | Identify | Which popular television | | 1) How persuasive is the player's |
| | | Ideal | character seems most | | reasoning for his/her choice of |
| | | Customer | like your ideal customer | | character? |
| | | | and why? | | 2) How effectively does the player |
| | | | | | back up their choice with key |
| | | | | | attributes of the ideal customer and |
| | | | | | how those attributes match with the |
| | | | | | tv character? |
| | | | Which member of your | | 1) How well does the player choose |
| | | | senior management team | | the correct member out of the list |
| | | | seems closest to your | | provided?2) How well does the |
| | | | ideal customer, and | | player back up their choice with |
| | | | why? | | key attributes of the ideal customer |
| | | | | | and how well do they explain how |
| | | | | | those attributes match with the |
| | | | | | member? |
| | | | What are the 10 most | | 1) How well does the player choose |
| | | | important defining | | the correct attributes for the ideal |
| | | | features of your ideal | | customer? |
| | | | customer (possible | | 2) How well does the player |
| | | | avatar game here). | | explain their ranking methodology? |
| | | | | | Does their attribute ranking reflect |
| | | | | | this methodology? |
| | | Conduct | Explore 3 project risks | 1) Evaluate each risk | N/A |
| | | Risk | involved with the | based on its a) uniqueness, | |
| | | Mitigation | development and launch | b)how well it falls under | |
| | | Analysis | of your product. | the specified category | |
| | | | Explore 3 business risks | (project, business, | N/A |
| | | | involved with the | technical), c) importance? | |
| | | | development and launch | 2) How well does the | |
| | | | of your product. | player come up with 3 | |
| | | | Explore 3 technical risks | unique mitigation | N/A |
| | | | involved with the | techniques? How well | |
| | | | development and launch | does the player spell out | |
| | | | of your product. | the steps for | |
| | | | Analyze potential | implementation of these | N/A |
| | | | barriers to entry for your | mitigation techniques? | |
| | | | product. | 3) How well does the | |
| | | | | player explain each | |
| | | | | mitigation technique and | |
| | | | | explain specifically how | |
| | | | | their technique would | |
| | | | | mitigate the associated | |
| | | | | risk? | |
| | Product | Define | Analyze VOC data that | 1) How well does the | 3) How effectively does the player |
| | Evaluation | the Voice | you currently have | player identify the main | use all VOC data? |
| | | of the | around related products | customer need? | 4) How well does the player tie in |
| | | Customer | | 2) How well does the | extra research about the VOC in |
| | | | | player prioritize the | context of the market? |
| | | | Interview 5 customer | different needs? | 3) How comprehensive are the |
| | | | support | | player's questions to isolate the |
| | | | representatives/managers | | main needs? |
| | | | to gather insights on the | | 4) How insightful is the data |
| | | | customer segment and | | gathered from the interviews? |
| | | | current related products | | |
| | | | Interview 5 sales people | | 3) How comprehensive are the |
| | | | who have insights in the | | player's questions to isolate the |
| | | | market segment you are | | main needs? |
| | | | going after - gather key | | 4) How insightful is the data |
| | | | information | | gathered from the interviews? |
| | | Conduct | Why have competitors | 1) How well does the | 3) How well does the player come |
| | | Competitor | designed their products | player address all of the | up with a comprehensive list of |
| | | Product | as they have? | major competitors' | features? |
| | | Analysis | | products? | 4) How well does the player |
| | | | | 2) How well does the | effectively justify why each feature |
| | | | | player tie in VoC analysis | exists? |
| | | | How have competitors | into their answer? | 3) How well does the player come |
| | | | differentiated their | | up with all differentiating features |
| | | | products? | | of the products? |
| | | | | | 4) How well does the player |
| | | | | | explain why these features |
| | | | | | differentiate the product and why |
| | | | | | the company may have chosen to |
| | | | | | include them in the product? |
| | | | Which are the best and | | 3) How well does the player |
| | | | worst products currently | | identify the similatrities in and |
| | | | available in the market? | | differences of each product? |
| | | | Why are these the best | | 4) How well does the player |
| | | | and worst? | | identify the strengths/weaknesses |
| | | | | | of each product? |
| | | | | | 5) How well does the player come |
| | | | | | to a conclusion on the most |
| | | | | | effective product? |
| | | Incorporate | How does your product | 1) How effectively does | 3) How well does the player justify |
| | | Changes | address the customer | the player address the | their answer by explaining specific |
| | | | need(s). | customers' needs in their | customer needs are not addressed? |
| | | | Analyze your product to | answer? | 3) How comprehensively does the |
| | | | see what is missing and | 2) How effectively does | player identify unique features that |
| | | | what is unnecessary? | the player show all major | competitor products have (ie tie in |
| | | | | features of each | the differentiating features found in |
| | | | | competitor? | Competitor Product Analysis) that |
| | | | | | should be incorporated? |
| | | | | | 4) How effective are the the |
| | | | | | player's suggestions for |
| | | | | | incorporation of these features? |
| | | | | | 5) How well does the player |
| | | | | | identify unnecessary features and |
| | | | | | explain why they are unnecessary? |
| | | | Can you change your | | 3) How well does the player |
| | | | product in any way to | | explain what features would |
| | | | make it better? | | differentiate the product from |
| | | | | | competitors'? |
| | | | | | 4) How clearly and specifically |
| | | | | | does the player explain how each |
| | | | | | feature would address which |
| | | | | | customer need? |
| | Growth | Identify | How can you use the | 1) How specific, accurate, | 4) How unique were the player's |
| | and | Market | product to reach other | and feasible were the | recommendations? |
| | Development | Expansion | market segments? | player's | |
| | | Opportunties | Explore secondary | recommendations? | 4) How effectively did the player |
| | | | customer | 2) How detailed was the | utilize resources like the Voice of |
| | | | markets/segments that | player's analysis? | the Customer and others? |
| | | | could be future targets. | 3) How clearly does the | |
| | | | Explore potential | player identify additional | 4) How well did the player |
| | | | opportunities for entry | segments and explain why | delineate the steps necessary to |
| | | | into foreign markets. | these would be beneficial | enter foreign markets? |
| | | | | segments to target? | |
| | | Identify | Could you make | 1) How well did the player | 3) How well does the player |
| | | Product | different versions of this | take into account the | explain the different versions and |
| | | Expansion | product? | customer's needs? | what benefits each version would |
| | | Opportunities | | 2) How detailed is the | provide? |
| | | | | players analysis of | 4) How well did the player take |
| | | | | possible attribute | into account data from previous |
| | | | | combinations? | product launches to understand |
| | | | | | what customers want to see? |
| | | | What enhancements | | 3) How well did the player make |
| | | | might you consider if | | adequate financial calculations to |
| | | | your budget was | | create a feasible analysis of |
| | | | increased? | | possible enhancements? |
| | | | Come up with two | | 3) How creative were the player's |
| | | | potentially game- | | ideas? |
| | | | changing ideas for your | | 4) Were the player's ideas feasible? |
| | | | product. | | |
| | Sales and | Develop | Develop a logo for this | 1) How creative was the | |
| | Marketing | Preliminary | product/line. | player in developing | |
| | | Marketing | Develop a slogan. | his/her logo/slogan/pitch? | |
| | | Materials | Come up with a short | 2) How accurately did the | |
| | | (Replaceable | elevator pitch. | player's product represent | |
| | | with | | the company and appeal to | |
| | | Marketing | | the target | |
| | | Quest) | | market/audience? | |
| | | | | 3) How well did the player | |
| | | | | justify their | |
| | | | | logo/slogan/pitch in terms | |
| | | | | of why they chose to | |
| | | | | portray the product in the | |
| | | | | way the did? | |
| | | | | 4) How well did the player | |
| | | | | incorporate the voice of | |
| | | | | the customer in their | |
| | | | | logo/slogan/pitch? | |
| | | Develop | Write a script that could | 1) How accurately did the | 2) How comprehensive is the |
| | | Preliminary | be used to sell your | player represent the | script that the player develops? |
| | | Sales | product | product and express its | 3) How persuasive is the player's |
| | | Pitch | | benefits? | script? |
| | | | Record yourself | | 2) How clear was the player's |
| | | | lecturing a friend about | | representation of the product and its |
| | | | the benefits of your | | benefits? |
| | | | product. | | 3) How comprehensible was the |
| | | | | | player's explanatin of the benefits |
| | | | | | of this product? |
| | | | Record yourself | | 2) How effective was the player in |
| | | | persuading a friend that | | persuading Gerald and informing |
| | | | your product is the best | | him of the benefits of this product? |
| | | | on the market. | | |
| Concept | Consumer | Conduct | Based on the current | 1) How accurately does | 4) How comprehensive is the |
| Testing | Response | Attribute | market and customers, | the player rank the | research the player conducts? |
| | | Importance | what are the most | important attributes? | 5) How well does the player show |
| | | Ranking | important attributes of | 2) How well does the | what sources and industry leaders |
| | | | the product? | player back up their | they consulted and explain why |
| | | | | rankings with appropriate | they chose these sources/leaders? |
| | | | Conduct a focus group to | justifications? | 4) How diverse was the player's |
| | | | rank the most important | 3) How insightful is the | focus group to determine the best |
| | | | attributes of the product. | player's analysis of the | attributes? |
| | | | | product's attributes? | 5) How unique and comprehensive |
| | | | | | were the player's exercises for the |
| | | | | | focus group, to best determine the |
| | | | | | important attributes for each |
| | | | | | consumer? |
| | | | Conduct a survey to rank | | 4) How successful was the player at |
| | | | the most important | | surveying an individual that is |
| | | | attributes of the product. | | similar to a likely consumer? |
| | | | | | 5) How unique and comprehensive |
| | | | | | are the player's questions to best |
| | | | | | determine the important attributes |
| | | | | | for the consumer? |
| | | | Conduct conjoint | | 4) How effective was the player at |
| | | | analysis to rank the | | determining all necessary factors to |
| | | | different product | | conduct conjoint analysis? |
| | | | attributes. | | 5) How clear and concise is the |
| | | | | | player's explanation of their |
| | | | | | analysis? |
| | | Conduct | Who would be good | | 3) How unique are the contacts the |
| | | Benefit | people to talk to in order | | player's came up with? (are they in |
| | | Segmentation | to learn more about the | | different segments?) |
| | | Analysis | various customer | | 4) How effective is the player's |
| | | | segments? | | methodology for contacting these |
| | | | | | contacts? |
| | | | | | 5) How well does the player |
| | | | | | explain why these points of contact |
| | | | | | would be beneficial for the |
| | | | | | company? |
| | | | Which market segments | | 3) How well did the player explain |
| | | | would be the ideal ones | | how the product would benefit each |
| | | | to target? | | segment? |
| | | | Talk to contacts in | | 3) How effective is the player's |
| | | | different market | | methodology for reaching out to |
| | | | segments. How could | | these contacts? |
| | | | they/this customer | | 4) How effective is the player's |
| | | | segment benefit from the | | methodology to gain insights from |
| | | | product? | | these points of contact? |
| Sales | Sales | Conduct | How do competitors' | 1) How comprehensive is | 3) How comprehensive is the |
| and | | Current | sales techniques | the player's analysis of | player's research? |
| Marketing | | Technique | compare with the | existing sales strategies? | |
| | | Analysis | techniques you came up | 2) How well does the | |
| | | | with? | player identify strengths | |
| | | | Conduct a focus group to | and weaknesses of the | 3) How effective and comphrensive |
| | | | analyze the strengths and | current marketing | are the exercies used in the focus |
| | | | weakness of your sales | strategy? | group to determine effective sales |
| | | | approach. | | strategies? |
| | | | | | 4) How beneficial was the feedback |
| | | | | | the player receive regarding |
| | | | | | previously developed sales |
| | | | | | strategies? |
| | | | Conduct a survey to | | 3) How comprehensive is the |
| | | | analyze the strengths and | | player's list of strengths and |
| | | | weaknesses of your sales | | weaknesses of the current sales |
| | | | approach. | | strategy? |
| | | | | | 4) How beneficial was the feedback |
| | | | | | for the sales strategies that the |
| | | | | | player was able to attain? |
| | | Create | Create the overall sales | 1) How comprehensive is | 4) How aware is the player of |
| | | Preliminary | strategy and a list of | the overall sales strategy | limited resources in creating this |
| | | Strategy | resources necessary to | the player presents? | list? |
| | | | create and sustain an | 2) How clear does the | 5) How well does the player |
| | | | effective sales strategy | player lay out the | deliniate between resources that the |
| | | | | steps/timeline for their | company has vs. resources that |
| | | | | strategy? | would need to be attained? |
| | | | Create the overall sales | 3) How feasible is the | 4) How well does the player |
| | | | strategy, rank your sales | player's strategy? | include market and consumer |
| | | | opportunities from high | | analsysis in ranking sales |
| | | | to low, and select which | | opportunities?5) How aware is the |
| | | | opportunities to focus on | | player of limited resources? |
| | | | initially based on the | | |
| | | | resources available to | | |
| | | | you | | |
| | | | Create the overall sales | | 4) How well does the player |
| | | | strategy and a customer | | include past sales strategieis in |
| | | | contact model which | | creating the customer contact |
| | | | should include the | | model? |
| | | | methods/frequencies | | 5) How comprehensive is the |
| | | | with which the team | | player's analysis in their choice of |
| | | | should contact the target | | method/frequency for customer |
| | | | customer | | contact? |
| | Marketing | Conduct | How do competitors' | 1) How comprehensive is | 3) How comprehensive is the |
| | | Current | sales and marketing | the player's analysis of | player's research? |
| | | Technique | techniques compare with | existing marketing | |
| | | Analysis | the techniques you came | strategies? | |
| | | | up with? | 2) How well does the | |
| | | | Conduct a focus group to | player identify strengths | 3) How effective and comphrensive |
| | | | analyze the strengths and | and weakness of the | are the exercies used in the focus |
| | | | weakness of your sales | current marketing | group to determine effective |
| | | | and marketing | strategy | marketing strategies? |
| | | | approaches. | | 4) How beneficial was the feedback |
| | | | | | the player receive regarding |
| | | | | | previously developed marketing |
| | | | | | strategies? |
| | | | Conduct a survey to | | 3) How comprehensive is the |
| | | | analyze the strengths and | | player's list of strengths and |
| | | | weaknesses of your sales | | weaknesses of the current |
| | | | and marketing approach. | | marketing strategy? |
| | | | Refine your sales and | | 4) How beneficial was the feedback |
| | | | marketing strategy | | for the marketing strategies that the |
| | | | accordingly. | | player was able to attain? |
| | | Create | Create a list of resources | 1) How well does the | 3) How feasible is the player's list |
| | | Preliminary | necessary to create and | player tie in and improve | of resources? |
| | | Strategy | sustain this strategy | upon the marketing work | |
| | | | Determine the ideal | cpmpleted in previous | 3) How well does the player |
| | | | mediums for marketing | tasks? | include analysis of the product in |
| | | | to reach your target | 2) How clear is the | their choice(s) of medium(s)?4) |
| | | | audience given limited | player's work for this | How comprehensive is the player's |
| | | | resources | marketing strategy? | analysis of the ideal customer in |
| | | | | | their choice(s)? |
| | | | Create a one-year | | 3) How feasible is the player's |
| | | | timeline for planning | | timline? |
| | | | and implementation of | | 4) How well does the player |
| | | | an overall marketing | | delegate tasks do different |
| | | | plan | | members of the marketing team? |
| | | | | | 5) How comprehensive and specific |
| | | | | | is the timelime in including |
| | | | | | resources needed? |

APPENDIX B
New Product Development - Business and Prototype Development

| | Task | | | | |
|---|---|---|---|---|---|
| Mission | Grouping | Task | Option | Task Rubric | Option Rubric |
| Business | | Competitive | What portion of the | 1) How comprehensively | N/A |
| Analysis | | Market Share | current market we | does the team address all | |
| | | Simulation | could hope to capture | aspects of the current | |
| | | | with this new product? | market when coming to a | |
| | | | | conclusion? | |
| | | | | 2) How well justified is | |
| | | | | the team's choice of the | |
| | | | | market portion? | |
| | | | | 3) How creative is the | |
| | | | | team's choice of | |
| | | | | presentation medium? | |
| | Price | Product Costs | What are some costs | 1) How comprehensive | 4) How well justified are the |
| | Analysis | | associated with the | is the player's research | player's estimation of the |
| | | | manufacturing of this | into all different costs? | costs? |
| | | | new product? | 2) How well did the | 5) How clearly does the |
| | | | | player organize the | player differentiate fixed and |
| | | | | different costs? | variable costs? |
| | | | What are some | 3) How effective are the | 4) How unique are the |
| | | | additional/unexpected | player's cost mitigation | additional costs that the |
| | | | costs associated with | techniques? | player comes up with? |
| | | | the manufacturing of | | |
| | | | this new product? | | |
| | | | What are some | | 4) How well does the player |
| | | | possible factors that | | project possible costs that |
| | | | could affect costs in | | may arise? |
| | | | the long run? | | |
| | | Price | How have changes in | 1) How well reasoned is | 2) How comprenehsive is the |
| | | Sensitivity | price affected | the player's analysis of | player's research of |
| | | Analysis | consumer behaviors | price sensitivity? | competitor's prices? |
| | | | for competitors' | | 3) How comprehensive is the |
| | | | products? | | player's research into |
| | | | | | consumer behavior? |
| | | | Conduct a survey of | | 2) How unique and |
| | | | consumers to | | comprehensive are the |
| | | | determine how much | | player's questions to best |
| | | | they would pay for | | determine the price |
| | | | this new product? | | sensitivity of the consumer? |
| | | Estimate | What should the initial | 1) How well reasoned is | N/A |
| | | Initial Price | price of the product | the teams's estimate of | |
| | | and Create a | be? What would the | the initial product? | |
| | | Profitability | breakeven point be, | 2) How comprehesive is | |
| | | Timeline | based on this price? | the team's approach to | |
| | | | | calculating the | |
| | | | | braekeven point? | |
| | | | | 3) How well does the | |
| | | | | team use all previous | |
| | | | | data? | |
| | | | | 4) How clear and | |
| | | | | organized is the team's | |
| | | | | analysis and | |
| | | | | presentation? | |
| | | Scope Market | Develop sales and | 1) How unique and | N/A |
| | | Strategy | marketing strategies to | creative are the team's | |
| | | | launch and grow the | sales and marketing | |
| | | | product. | strategies?2) How well | |
| | | | | does the team explain | |
| | | | | how these strategies | |
| | | | | would help launch and | |
| | | | | grow the product?3) | |
| | | | | How well justified are | |
| | | | | the team's approaches in | |
| | | | | terms of how they will | |
| | | | | target the best consumer | |
| | | | | segment?4) How well | |
| | | | | would the strategy help | |
| | | | | with market entry and | |
| | | | | positioning?5) How well | |
| | | | | does the team do in | |
| | | | | explaining expansion | |
| | | | | stratgies and providing a | |
| | | | | growth timeline? | |
| Beta and | Prototype | Prototype | Work with your team | 1) How well does the | N/A |
| Market | Development | Blueprint | to develop a blueprint | team tie in all important | |
| Testing | | | of your ideal | features into the | |
| | | | prototype. The top x | prototype?2) How | |
| | | | prototypes will be | creative and effective is | |
| | | | chosen for | the protype in dealing | |
| | | | development. | with the customer | |
| | | | | pain?3) How feasible is | |
| | | | | the prototype? | |
| | | Analyze | Conduct a SWOT | 1) How effecitvely and | 3) How comprehensive is the |
| | | Functioning | analysis of each | comprehensively does | SWOT Analysis? |
| | | Prototypes | prototype. | the player analyze each | |
| | | | Conduct a feasibility | prototype? | 3) How comprehensive is the |
| | | | analysis of each | 2) How well reasoned is | feasibility analysis? |
| | | | prototype. | the player's ranking of | 4) How well does the player |
| | | | | the protype? | weigh the advantages and |
| | | | | | disadvantages of each |
| | | | | | prototype? |
| | | | Record yourself using | | 3) How creative is the |
| | | | each of the prototypes | | informational video? |
| | | | and give a verbal | | 4) How well does the player |
| | | | SWOT analysis of | | get across the SWOT |
| | | | each. | | analysis in the video? |
| | Customer | Customer | How could you obtain | 1) How comprehensive | 2) How unique and effective |
| | Response | Feedback | mass consumer | and effective is the | are the methods of obtaining |
| | | | feedback on the | player's methodology for | feedback the player attains? |
| | | | prototypes? | how to attain feedback? | 3) How comprehensive is the |
| | | | | | player's methodology for |
| | | | | | implementing these |
| | | | | | methods? |
| | | | Conduct a survey to | | 2) How unique and |
| | | | collect feedback on the | | comprehensive are the |
| | | | prototypes. | | player's questions to get the |
| | | | | | best possible feedback on the |
| | | | | | protoypes? |
| | | | | | 3) How useful is the |
| | | | | | feedback the player attains? |
| | | | Conduct a focus group | | 2) How effective are the |
| | | | to collect feedback on | | exercies and questions the |
| | | | the prototypes. | | player develops for the focus |
| | | | | | group to attain valuable |
| | | | | | feedback? |
| | | | | | 3) How useful is the |
| | | | | | feedback the player attains? |
| | | Incorporate | Which customer | 1) How well does the | 3) How comprehesnive is the |
| | | Features | concerns does each | player incorporate all | player's research?4) How |
| | | | prototype addresses? | customer feedback?2) | justified is the prioritization |
| | | | | Ho w justified is the | of customer concerns? |
| | | | Conduct a SWOT | player's ranking of the | 3) How comprehensive is the |
| | | | analysis of each | different protoypes? | SWOT analysis based on the |
| | | | prototype now that | | customer feedback? |
| | | | you have received | | |
| | | | customer feedback. | | |
| | | | Based on the Voice of | | 3) How unique and feasbile |
| | | | the Customer, what | | are the players changes? |
| | | | key changes must be | | 4) How well does the player |
| | | | implemented for each | | justify why these changes |
| | | | prototype? | | need to be made? |
| | | Develop a | Pick which | 1) How persuasive is the | N/A |
| | | Pitch | product/protoype best | team's choice for the | |
| | | | fits the Voice of the | best-fit protype? | |
| | | | Customer | 2) How creative is the | |
| | | | | presentation/pitch? | |
| | | | | 3) How well does the | |
| | | | | team explain how the | |
| | | | | product addresses the | |
| | | | | customer pain? | |

Once the best-fit prototype has been launched on a small scale in select markets . . .

| | | | | |
|---|---|---|---|---|
| Test | Monitor | Conduct a survey to | 1) How comprehensive and | 4) How unique and |
| Marketing | Consumer | collect feedback from | useful is the feedback the | comprehensive are the |
| | Reactions and | the trial run. Present key | player gains from the | player's questions to get |
| | Acceptance | insights and refine the | customers? | the best possible |
| | | final product. | 2) How useful are the | feedback on the |
| | | | insights the player comes | protoype? |
| | | Conduct a focus group to | up with based on the | 4) How effective are the |
| | | collect feedback from | feedback? | exercies and questions |
| | | the trial run. Present key | 3) How feasible and | the player develops for |
| | | insights and refine the | effecitve are the player's | the focus group to attain |
| | | final product. | suggested refinements? | valuable feedback on |
| | | | | the prototype? |
| | Refine | Based on the trial | 1) How comprehensive is | 3) How unique and |
| | Marketing | launch, what are some | the player's review in the | important are the flaws |
| | Strategy | problems with the | current marketing | the player comes up |
| | | current marketing | strategy?2) How well does | with?4) How well does |
| | | strategy? | the player compare the | the player incorporate |
| | | | company's marketing | customer feedback to |
| | | | strategy with competitors | show how these are |
| | | | for strengths and | truly flaws? |
| | | How could you improve | weaknesses? | 3) How unique and |
| | | upon the current | | effective are the changes |
| | | marketing strategy? | | the player proposes? |
| | | | | 4) How well does the |
| | | | | player explain how |
| | | | | these changes will fix |
| | | | | flaws within the |
| | | | | strategy? |
| | | Draft a revised | | 3) How comprehensive |
| | | marketing strategy for | | is the player's new |
| | | the full-scale launch. | | marketing strategy? |
| | | | | 4) How well does the |
| | | | | player explain the |
| | | | | necessary changes as |
| | | | | well as explain how to |
| | | | | implement these |
| | | | | changes and what flaws |
| | | | | these changes will fix? |
| | Refine | How could the pricing | 1) How well does the team | N/A |
| | Pricing | model be improved to | utilize different tools to | |
| | Model | maximize profits? | revise the pricing model? | |
| | | | 2) How well does the team | |
| | | | explain the necessary | |
| | | | revisions? | |
| | | | 3) How well does the | |
| | | | player project how these | |
| | | | revisions will benefit the | |
| | | | pricing model? | |
| | Plan for | Are there additional | 1) How comprehensive is | N/A |
| | Scalability | resources needed to | the team's research into | |
| | | bring the product to | necessary resources? | |
| | | market? | 2) How effective is the | |
| | | | team's plan for utilization | |
| | | | of these resources? | |
| | | | 3) How well does the team | |
| | | | project how using these | |
| | | | resources will benefit the | |
| | | | company? | |

What is claimed is:

1. A system comprising:
at least one processor and a memory; and
a gamification engine to manage business processes, including at least project management processes, as augmented reality games in which members of an organization are selected to be players of games in which a quest corresponds to a major business process, a mission corresponds to a phase of a quest, and each mission includes at least one task, the augmented reality game including game scoring of tasks.

2. The system of claim 1, wherein the gamification engine manages learning within an organization by having learning events managed as part of the augmented reality game as tasks.

3. The system of claim 1, wherein the gamification engine includes a quest creation module, a quest assignment module, a quest tracking and participation module, a quest scoring module, and a rewards and recognition module.

4. The system of claim 1, where the system further comprises:
a project management engine;
a learning management engine; and
a content management engine;
wherein the augmented reality game is integrated with project management, learning management, and content management.

5. The system of claim 1, wherein individual players are provided options for selecting or rejecting tasks in a mission with individual missions having individual point counts.

6. The system of claim 1, further comprising a user interface for a consultant to provide new quests into the system.

7. The system of claim 1, further comprising a user interface for a manager to create and manage quests.

8. The system of claim 1, wherein each task includes a scoring rubric.

9. The system of claim 8, wherein at least one scoring rubric includes at least one criterion related to quality.

10. The system of claim 1, wherein leader boards are generated based on the scores of tasks performed by individual players.

11. The system of claim 1 in combination with a web server to interface with at least one networked client device.

12. The system of claim 1, wherein the augmented reality game provides motivation for sociable business behaviors within an enterprise.

13. A method of gamification of project management and learning management, comprising:
generating a gamification library to gamify business processes, the gamification library including templates and model quests, missions, tasks, and rubrics for scoring tasks, in which a quest corresponds to a major business process, a mission corresponds to a phase of a quest, and each mission includes at least one task; and
providing access to a choreographer to adapt and edit the templates and models in the gamification library to generate a new quest to gamify a new business process.

14. The method of claim 13, further comprising a taxonomy of quests and resources, wherein external libraries of resources are incorporated into the taxonomy.

15. The method of claim 13, further comprising receiving independently authored quests.

16. A method of gamification of project management and learning management, comprising:
receiving access to a gamification library to gamify business processes, the gamification library including templates and model quests, missions, tasks, and rubrics for scoring tasks, in which a quest corresponds to a major business process, a mission corresponds to a phase of a quest, and each mission includes at least one task; and
adapting and editing the templates and models in the gamification library to generate a new quest to gamify a new business process.

17. A method, comprising:
generating an augmented reality game in which members of an organization are selected to be players of games in which a quest corresponds to a major business process including at least project management, a mission corresponds to a phase of a quest, and each mission includes at least one task, the augmented reality game including game scoring of tasks.

18. The method of claim 17, where at least one task includes a learning activity such that the business process includes learning management.

19. The method of claim 17, wherein the method includes creating a new quest, assigning players to a quest, tracking of the status of participation in the quest, scoring players, and providing rewards and recognitions for players.

20. The method of claim 17, where the method further comprises integrating the augmented reality game with:
project management;
learning management; and
content management.

21. The method of claim 17, wherein individual players are provided options for selecting or rejecting tasks in a mission with individual missions having individual point counts.

22. The method of claim 17, further comprising providing a user interface for a consultant to provide new quests.

23. The method of claim 17, wherein each task includes a scoring rubric.

24. The method of claim 17, wherein at least one scoring rubric includes at least one criterion related to quality.

25. The method of claim 17, further comprising generating leader boards based on the scores of tasks performed by individual players.

26. The method of claim 17, further comprising providing access to the augmented reality game to at least one client device via a networked connection.

27. A system, comprising:
at least one processor and a memory;
a gamification engine to manage business processes, including at least learning management processes, as augmented reality games in which members of an organization are selected to be players of games in which a quest corresponds to a major business process having a learning component, a mission corresponds to a phase of a quest, and each mission includes at least one task, the augmented reality game including game scoring of tasks; and
a content storage repository and an interface to receive content from third party providers based on a taxonomy of learning content mirroring a taxonomy of the tasks;
wherein a business learning process is gamified and content from third party providers is provided that is compatible with the business learning process.
